(19) United States
(12) Patent Application Publication
(10) Pub. No.: US 2023/0224801 A1
(43) Pub. Date: Jul. 13, 2023

(54) SWITCHING BETWEEN SEARCH SPACE SET GROUPINGS

(71) Applicant: QUALCOMM Incorporated, San Diego, CA (US)

(72) Inventors: Mickael MONDET, Louannec (FR); Prashanth Haridas HANDE, San Diego, CA (US); Ravi AGARWAL, San Diego, CA (US); Peerapol TINNAKORNSRISUPHAP, San Diego, CA (US)

(21) Appl. No.: 17/571,921

(22) Filed: Jan. 10, 2022

(51) Int. Cl. H04W 48/16; H04W 76/28

(52) U.S. Cl. CPC H04W 48/16; H04W 76/28

(57) ABSTRACT

Aspects relate to switching between different search space set groupings. A base station (BS) may send an indication to a user equipment (UE) to instruct the UE to switch from a first search space set grouping (SSSG) to a second SSSG. For example, the BS may send this indication after the BS transmits a first data burst to the UE. In some examples, the UE may then switch back to the first SSSG upon expiration of a timer. For example, the BS may configure the UE with a timer value (e.g., an absolute value, a relative value, or an indication thereof) that the UE may use to determine when to switch back to the first SSSG to receive a second data burst from the base station. In some examples, the UE may switch back to the first SSSG based on a discontinuous reception duration.

### TECHNICAL FIELD

The technology discussed below relates generally to wireless communication more particularly, to switching between different search space set groupings.

### INTRODUCTION

Next-generation wireless communication systems (e.g., 5GS) may include a 5G core network and a 5G radio access network (RAN), such as a New Radio (NR)-RAN. The NR-RAN supports communication via one or more cells. For example, a wireless communication device such as a user equipment (UE) may access a first cell of a first base station (BS) such as a gNB and/or access a second cell of a second base station.

A base station may schedule access to a cell to support access by multiple UEs. For example, a base station may allocate different resources (e.g., time domain and frequency domain resources) for different UEs operating within a cell of the base station.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In some examples, a user equipment may include a transceiver, a memory, and a processor coupled to the transceiver and the memory. The processor may be configured to receive, via the transceiver, a search space set grouping configuration including a first search space set group and a second search space set group, receive, via the transceiver, a first data burst of a periodic data transmission, receive, via the transceiver, duration information for a search space set group switch associated with the first data burst, receive, via the transceiver, an indication to switch to the second search space set group, switch to the second search space set group based on the indication, and receive, via the transceiver, a second data burst of the periodic data transmission after switching to the first search space set group at a time that is based on the duration information.

In some examples, a method for wireless communication at a user equipment is disclosed. The method may include receiving a search space set grouping configuration including a first search space set group and a second search space set group, receiving a first data burst of a periodic data transmission, receiving duration information for a search space set group switch associated with the first data burst, receiving an indication to switch to the second search space set group, switching to the second search space set group based on the indication, and receiving a second data burst of the periodic data transmission after switching to the first search space set group at a time that is based on the duration information.

In some examples, a user equipment may include means for receiving a search space set grouping configuration including a first search space set group and a second search space set group, means for receiving a first data burst of a periodic data transmission, means for receiving duration information for a search space set group switch associated with the first data burst, means for receiving an indication to switch to the second search space set group, means for switching to the second search space set group based on the indication, and means for receiving a second data burst of the periodic data transmission after switching to the first search space set group at a time that is based on the duration information.

In some examples, a non-transitory computer-readable medium has stored therein instructions executable by one or more processors of a user equipment to receive a search space set grouping configuration including a first search space set group and a second search space set group, receive a first data burst of a periodic data transmission, receive duration information for a search space set group switch associated with the first data burst, receive an indication to switch to the second search space set group, switch to the second search space set group based on the indication, and receive a second data burst of the periodic data transmission after switching to the first search space set group at a time that is based on the duration information.

In some examples, a base station may include a transceiver, a memory, and a processor coupled to the transceiver and the memory. The processor may be configured to transmit, via the transceiver, a search space set grouping configuration including a first search space set group and a second search space set group, transmit, via the transceiver, a first data burst of a periodic data transmission, transmit, via the transceiver, duration information for a search space set group switch associated with the first data burst, transmit, via the transceiver, an indication to switch to the second search space set group, and transmit, via the transceiver, a second data burst of the periodic data transmission.

In some examples, a method for wireless communication at a base station is disclosed. The method may include transmitting a search space set grouping configuration including a first search space set group and a second search space set group, transmitting a first data burst of a periodic data transmission, transmitting duration information for a search space set group switch associated with the first data burst, transmitting an indication to switch to the second search space set group, and transmitting a second data burst of the periodic data transmission.

In some examples, a base station may include means for transmitting a search space set grouping configuration including a first search space set group and a second search space set group, means for transmitting a first data burst of a periodic data transmission, means for transmitting duration information for a search space set group switch associated with the first data burst, means for transmitting an indication to switch to the second search space set group, and means for transmitting a second data burst of the periodic data transmission.

In some examples, a non-transitory computer-readable medium has stored therein instructions executable by one or more processors of a base station to transmit a search space set grouping configuration including a first search space set group and a second search space set group, transmit a first data burst of a periodic data transmission, transmit duration information for a search space set group switch associated with the first data burst, transmit an indication to switch to the second search space set group, and transmit a second data burst of the periodic data transmission,

These and other aspects of the disclosure will become more fully understood upon a review of the detailed description, which follows. Other aspects, features, and examples of the present disclosure will become apparent to those of ordinary skill in the art, upon reviewing the following description of specific, example aspects of the present disclosure in conjunction with the accompanying figures. While features of the present disclosure may be discussed relative to certain examples and figures below, all examples of the present disclosure can include one or more of the advantageous features discussed herein. In other words, while one or more examples may be discussed as having certain advantageous features, one or more of such features may also be used in accordance with the various examples of the disclosure discussed herein. In similar fashion, while example aspects may be discussed below as device, system, or method examples it should be understood that such example aspects can be implemented in various devices, systems, and methods.

### BRIEF DESCRIPTION OF THE DRAWINGS

FIG. 1 is a schematic illustration of a wireless communication system according to some aspects.

FIG. 2 is a conceptual illustration of an example of a radio access network according to some aspects.

FIG. 3 is a schematic illustration of an example of wireless resources in an air interface utilizing orthogonal frequency divisional multiplexing (OFDM) according to some aspects.

FIG. 4 is a schematic illustration of an example of a downlink control region of a slot according to some aspects.

FIG. 5 is a schematic illustration of an example of a control channel element structure according to some aspects.

FIG. 6 is a schematic illustration of an example of downlink time-frequency resources according to some aspects,

FIG. 7 is a conceptual illustration of an example of communication state transitions according to some aspects.

FIG. 8 is a conceptual illustration of an example of a discontinuous reception (DRX) cycle according to some aspects.

FIG. 9 is a signaling diagram illustrating an example of switching between different search space set groupings (SSSGs) according to some aspects.

FIG. 10 is a timing diagram illustrating an example of switching between different SSSGs according to some aspects.

FIG. 11 is a timing diagram illustrating an example of a timer value for switching between different SSSGs according to some aspects.

FIG. 12 is a timing diagram illustrating an example of jitter that may occur in conjunction with switching between different SSSGs according to some aspects.

FIG. 13 is a signaling diagram illustrating an example of determining a timer value for switching between different SSSGs according to some aspects.

FIG. 14 is a signaling diagram illustrating an example of switching between different SSSGs in conjunction with discontinuous reception according to some aspects.

FIG. 15 is a block diagram illustrating an example of a hardware implementation for a user equipment employing a processing system according to some aspects.

FIG. 16 is a flow chart of an example method for switching between different SSSGs based on duration information according to some aspects.

FIG. 17 is a flow chart of an example method for switching between different SSSGs based on a discontinuous reception duration according to some aspects.

FIG. 18 is a block diagram illustrating an example of a hardware implementation for a base station employing a processing system according to some aspects.

FIG. 19 is a flow chart of an example method for transmitting duration information for switching between different SSSGs according to some aspects.

FIG. 20 is a flow chart of an example method for indicating that a switch between different SSSGs is based on a discontinuous reception duration according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via, integrated chip examples and other non-module-component based devices (e.g., end-user devices, vehicles, communication devices, computing devices, industrial equipment, retail/purchasing devices, medical devices, artificial intelligence-enabled (AI-enabled) devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described examples. For example, transmission and reception of wireless signals necessarily includes a number of components for analog and digital purposes (e.g., hardware components including antenna, radio frequency (RF) chains, power amplifiers, modulators, buffer, processor(s), interleaver, adders/summers, etc.). It is intended that innovations described herein may be practiced in a wide variety of devices, chip-level components, systems, distributed arrangements, disaggregated arrangements (e.g., base station and/or UE), end-user devices, etc., of varying sizes, shapes, and constitution.

Various aspects of the disclosure relate to switching between different search space set groupings (SSSGs). For example, a base station may configure a user equipment with multiple SSSGs. In some examples, a first search space set grouping (SSSG) may be designated for monitoring a physical downlink control channel (PDCCH) and a second SSSG may be designated for not monitoring a PDCCH.

The base station may send an indication to the user equipment to instruct the user equipment to switch from the first SSSG to the second SSSG. For example, after the base station transmits a data burst to the user equipment, the base station may instruct the user equipment to switch from the first SSSG to the second SSSG so that the user equipment may save power by not monitoring the PDCCH.

In some examples, the user equipment may switch back to the first SSSG upon expiration of a timer. For example, the base station may configure the user equipment with a timer value (e.g., an absolute value, a relative value, or an indication thereof) that the user equipment may use to determine when to switch back to the first SSSG (after switching to the second SSSG in response to the instruction from the base station). In this way, the user equipment may recommence monitoring the downlink (e.g., the PDCCH and/or a physical downlink shared channel (PDSCH)) and thereby receive a subsequent data burst transmitted by the base station.

In some examples, the user equipment may switch back to the first SSSG based on a discontinuous reception (DRX) duration. For example, the base station may configure the user equipment to switch back to the first SSSG (after switching to the second SSSG in response to the instruction from the base station) at the commencement of a DRX ON duration for the user equipment (e.g., when the user equipment switches from a low power mode to a high power mode according to a configured DRX cycle). In this way, the user equipment may recommence monitoring the PDCCH and thereby receive a subsequent data burst transmitted by the base station.

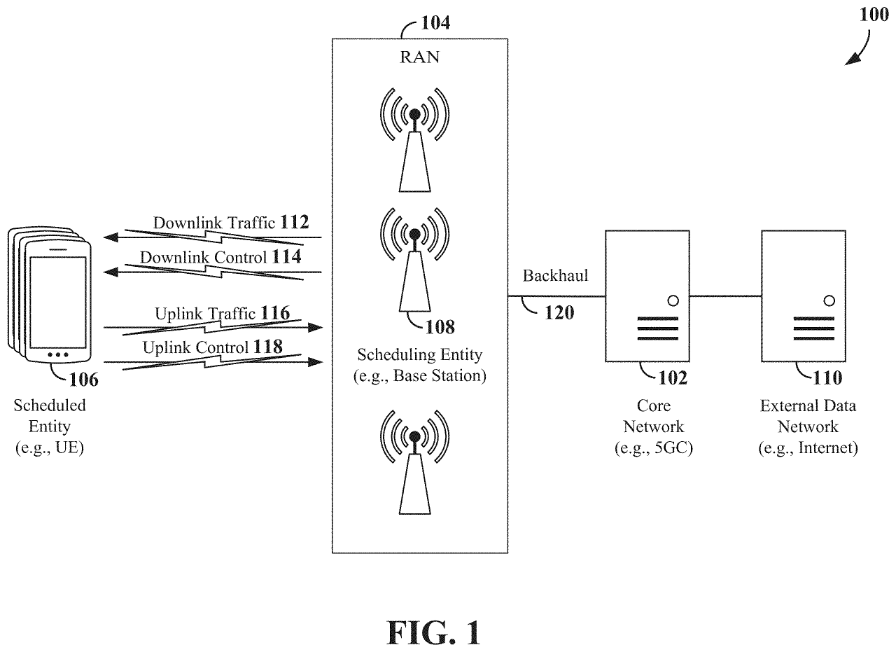

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a wireless communication system 100. The wireless communication system 100 includes three interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3rd Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as Long-Term Evolution (LTE). The 3GPP refers to this hybrid RAN as a next-generation RAN, or NG-RAN. In another example, the RAN 104 may operate according to both the LTE and 5G NR standards. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), a transmission and reception point (TRP), or some other suitable terminology. In some examples, a base station may include two or more TRPs that may be collocated or non-collocated. Each TRP may communicate on the same or different carrier frequency within the same or different frequency hand. In examples where the RAN 104 operates according to both the LTE and 5G NR standards, one of the base stations 108 may be an LTE base station, while another base station may be a 5G NR base station.

The radio access network 104 is further illustrated supporting wireless communication for multiple mobile apparatuses. A mobile apparatus may be referred to as user equipment (UE) 106 in 3GPP standards, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE 106 may be an apparatus that provides a user with access to network services. In examples where the RAN 104 operates according to both the LTE and 5G NR standards, the UE 106 may be an Evolved-Universal Terrestrial Radio Access Network-New Radio dual connectivity (EN-DC) UE that is capable of simultaneously connecting to an LTE base station and an NR base station to receive data packets from both the LTE base station and the NR base station.

Within the present document, a mobile apparatus need not necessarily have a capability to move, and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc., electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an Internet of Things (IoT).

A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, agricultural equipment, etc. Still further, a mobile apparatus may provide for connected medicine or telemedicine support, i.e., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between a RAN 104 and a UE 106 may be described as utilizing an air interface. Transmissions over the air interface from a base station (e.g., base station 108) to one or more UEs (e.g., UE 106) may be referred to as downlink (DL) transmission. In some examples, the term downlink may refer to a point-to-multipoint transmission originating at a base station (e.g., base station 108). Another way to describe this point-to-multipoint transmission scheme may be to use the term broadcast channel multiplexing. Transmissions from a UE (e.g., UE 106) to a base station (e.g., base station 108) may be referred to as uplink (UL) transmissions. In some examples, the term uplink may refer to a point-to-point transmission originating at a UE (e.g., UE 106).

In some examples, access to the air interface may be scheduled, wherein a scheduling entity (e.g., a base station 108) allocates resources for communication among some or all devices and equipment within its service area or cell. Within the present disclosure, as discussed further below, the scheduling entity may be responsible for scheduling, assigning, reconfiguring, and releasing resources for one or more scheduled entities (e.g., UEs). That is, for scheduled communication, a plurality of UEs 106, which may be scheduled entities, may utilize resources allocated by a scheduling entity (e.g., a base station 108).

Base stations 108 are not the only entities that may function as scheduling entities. That is, in some examples, a UE may function as a scheduling entity, scheduling resources for one or more scheduled entities (e.g., one or more other UEs). For example, UEs may communicate with other UEs in a peer-to-peer or device-to-device fashion and/or in a relay configuration.

As illustrated in FIG. 1, a scheduling entity (e.g., a base station 108) may broadcast downlink traffic 112 to one or more scheduled entities (e.g., a UE 106). Broadly, the scheduling entity is a node or device responsible for scheduling traffic in a wireless communication network, including the downlink traffic 112 and, in some examples, uplink traffic 116 and/or uplink control information 118 from one or more scheduled entities to the scheduling entity. On the other hand, the scheduled entity is a node or device that receives downlink control information 114, including but not limited to scheduling information (e.g., a grant), synchronization or timing information, or other control information from another entity in the wireless communication network such as the scheduling entity.

In addition, the uplink control information 118, downlink control information 114, downlink traffic 112, and/or uplink traffic 116 may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols in some examples. A subframe may refer to a duration of 1 millisecond (ms). Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

In general, base stations 108 may include a backhaul interface for communication with a backhaul 120 of the wireless communication system. The backhaul 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100, and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

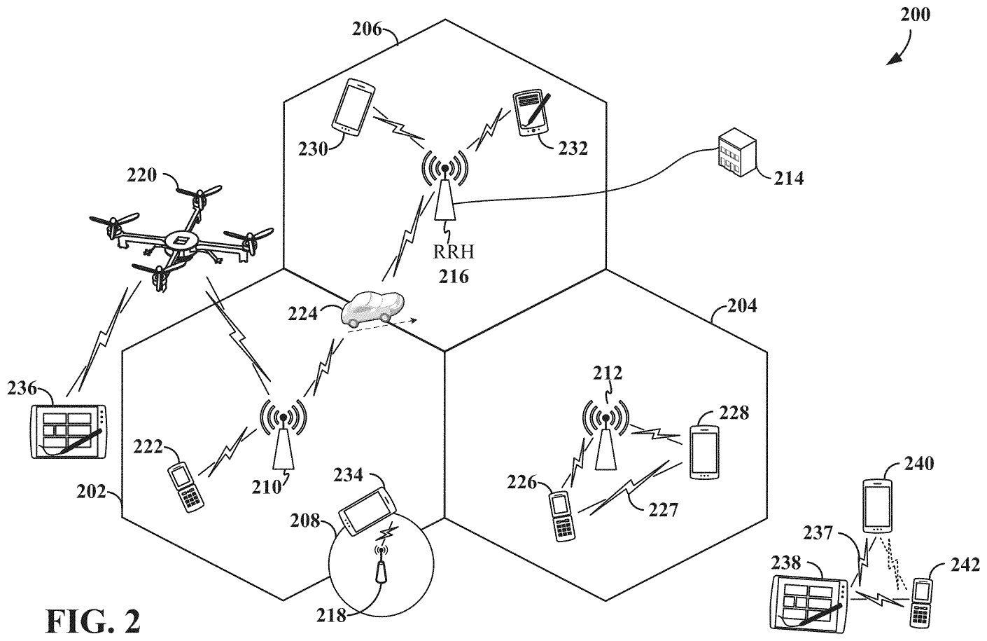

Referring now to FIG. 2, by way of example and without limitation, a schematic illustration of a radio access network (RAN) 200 is provided. In some examples, the RAN 200 may be the same as the RAN 104 described above and illustrated in FIG. 1.

The geographic area covered by the RAN 200 may be divided into cellular regions (cells) that can be uniquely identified by a user equipment (UE) based on an identification broadcasted from one access point or base station. FIG. 2 illustrates cells 202, 204, 206, and 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

Various base station arrangements can be utilized. For example, in FIG. 2, two base stations 210 and 212 are shown in cells 202 and 204; and a base station 214 is shown controlling a remote radio head (RRH) 216 in cell 206. That is, a base station can have an integrated antenna or can be connected to an antenna or RRH by feeder cables. In the illustrated example, the cells 202, 204, and 206 may be referred to as macrocells, as the base stations 210, 212, and 214 support cells having a large size. Further, a base station 218 is shown in the cell 208, which may overlap with one or more macrocells. In this example, the cell 208 may be referred to as a small cell (e.g., a microcell, femtocell, home base station, home Node B, home eNode B, etc.), as the base station 218 supports a cell having a relatively small size. Cell sizing can be done according to system design as well as component constraints.

It is to be understood that the RAN 200 may include any number of wireless base stations and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as the base station/scheduling entity described above and illustrated in FIG. 1.

FIG. 2 further includes an unmanned aerial vehicle (UAV) 220, which may be a drone or quadcopter. The UAV 220 may be configured to function as a base station, or more specifically as a mobile base station. That is, in some examples, a cell may not necessarily be stationary, and the geographic area of the cell may move according to the location of a mobile base station, such as the UAV 220.

Within the RAN 200, the cells may include UEs that may be in communication with one or more sectors of each cell. Further, each base station 210, 212, 214, and 218 may be configured to provide an access point to a core network 102 (see FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RRH 216; and UE 234 may be in communication with base station 218. In some examples, the UEs 222, 224, 226, 228, 230, 232, 234, 236, 238, 240, and/or 242 may be the same as the UE/scheduled entity described above and illustrated in FIG. 1. In some examples, the UAV 220 (e.g., the quadcopter) can be a mobile network node and may be configured to function as a UE. For example, the UAV 220 may operate within cell 202 by communicating with base station 210.

In a further aspect of the RAN 200, sidelink signals may be used between UEs without necessarily relying on scheduling or control information from a base station. Sidelink communication may be utilized, for example, in a device-to-device (D2D) network, peer-to-peer (P2P) network, vehicle-to-vehicle (V2V) network, vehicle-to-everything (V2X) network, and/or other suitable sidelink network. For example, two or more UEs (e.g., UEs 238, 240, and 242) may communicate with each other using sidelink signals 237 without relaying that communication through a base station. In some examples, the UEs 238, 240, and 242 may each function as a scheduling entity or transmitting sidelink device and/or a scheduled entity or a receiving sidelink device to schedule resources and communicate sidelink signals 237 therebetween without relying on scheduling or control information from a base station. In other examples, two or more UEs (e.g., UEs 226 and 228) within the coverage area of a base station (e.g., base station 212) may also communicate sidelink signals 227 over a direct link (sidelink) without conveying that communication through the base station 212. In this example, the base station 212 may allocate resources to the UEs 226 and 228 for the sidelink communication.

In the RAN 200, the ability for a UE to communicate while moving, independent of its location, is referred to as mobility. The various physical channels between the UE and the radio access network are generally set up, maintained, and released under the control of an access and mobility management function (AMF, not illustrated, part of the core network 102 in FIG. 1), which may include a security context management function (SCMF) that manages the security context for both the control plane and the user plane functionality, and a security anchor function (SEAF) that performs authentication.

A RAN 200 may utilize DL-based mobility or UL-based mobility to enable mobility and handovers (i.e., the transfer of a UE's connection from one radio channel to another). In a network configured for DL-based mobility, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, UE 224 (illustrated as a vehicle, although any suitable form of UE may be used) may move from the geographic area corresponding to its serving cell (e.g., the cell 202) to the geographic area corresponding to a neighbor cell (e.g., the cell 206). When the signal strength or quality from the neighbor cell exceeds that of the serving cell for a given amount of time, the UE 224 may transmit a reporting message to its serving base station (e.g., the base station 210) indicating this condition. In response, the UE 224 may receive a handover command, and the UE may undergo a handover to the cell 206.

In a network configured for UL-based mobility, UL reference signals from each UE may be utilized by the network to select a serving cell for each UE. In some examples, the base stations 210, 212, and 214/216 may broadcast unified synchronization signals (e.g., unified Primary Synchronization Signals (PSSs), unified Secondary Synchronization Signals (SSSS) and unified Physical Broadcast Channels (PBCH)). The UEs 222, 224, 226, 228, 230, and 232 may receive the unified synchronization signals, derive the carrier frequency and slot timing from the synchronization signals, and in response to deriving timing, transmit an uplink pilot or reference signal. The uplink pilot signal transmitted by a UE (e.g., UE 224) may be concurrently received by two or more cells (e.g., base stations 210 and 214/216) within the RAN 200. Each of the cells may measure a strength of the pilot signal, and the radio access network (e.g., one or more of the base stations 210 and 214/216 and/or a central node within the core network) may determine a serving cell for the UE 224. As the UE 224 moves through the RAN 200, the network may continue to monitor the uplink pilot signal transmitted by the UE 224. When the signal strength or quality of the pilot signal measured by a neighboring cell exceeds that of the signal strength or quality measured by the serving cell, the RAN 200 may handover the UE 224 from the serving cell to the neighboring cell, with or without informing the UE 224.

Although the synchronization signal transmitted by the base stations 210, 212, and 214/216 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the UE and the network, since the number of mobility messages that need to be exchanged between the UE and the network may be reduced.

In various implementations, the air interface in the RAN 200 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without the need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple radio access technologies (RATs). For example, the holder of a license for a portion of licensed spectrum may provide licensed shared access (LSA) to share that spectrum with other parties, e.g., with suitable licensee-determined conditions to gain access.

The air interface in the RAN 200 may utilize one or more multiplexing and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

The air interface in the RAN 200 may further utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancelation technologies. Full-duplex emulation is frequently implemented for wireless links by utilizing frequency division duplex (FDD) or spatial division duplex (SDD). In FDD, transmissions in different directions operate at different carrier frequencies. In SDD, transmissions in different directions on a given channel are separate from one another using spatial division multiplexing (SDM). In other examples, full-duplex communication may be implemented within unpaired spectrum (e.g., within a single carrier bandwidth), where transmissions in different directions occur within different sub-hands of the carrier bandwidth. This type of full-duplex communication may be referred to as sub-band full-duplex (SBFD), cross-division duplex (xDD), or flexible duplex.

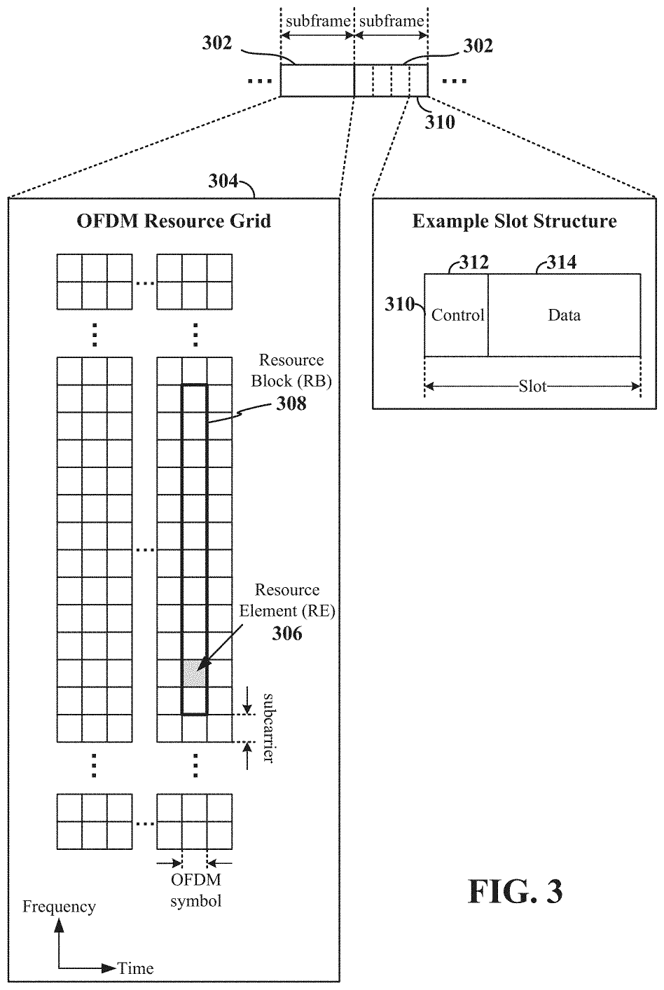

Various aspects of the present disclosure will be described with reference to an OFDM waveform, an example of which is schematically illustrated in FIG. 3. It should be understood by those of ordinary skill in the art that the various aspects of the present disclosure may be applied to an SC-FDMA waveform in substantially the same way as described herein below. That is, while some examples of the present disclosure may focus on an OFDM link for clarity, it should be understood that the same principles may be applied as well to SC-FDMA waveforms.

Referring now to FIG. 3, an expanded view of an example subframe 302 is illustrated, showing an OFDM resource grid. However, as those skilled in the art will readily appreciate, the physical (PHY) layer transmission structure for any particular application may vary from the example described here, depending on any number of factors. Here, time is in the horizontal direction with units of OFDM symbols; and frequency is in the vertical direction with units of subcarriers of the carrier.

The resource grid 304 may be used to schematically represent time-frequency resources for a given antenna port. That is, in a multiple-input-multiple-output (MIMO) implementation with multiple antenna ports available, a corresponding multiple number of resource grids 304 may be available for communication. The resource grid 304 is divided into multiple resource elements (REs) 306. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 308, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 308 entirely corresponds to a single direction of communication (either transmission or reception for a given device).

A set of continuous or discontinuous resource blocks may be referred to herein as a Resource Block Group (RBG), sub-band, or bandwidth part (BWP). A set of sub-bands or BWPs may span the entire bandwidth. Scheduling of scheduled entities (e.g., UEs) for downlink, uplink, or sidelink transmissions typically involves scheduling one or more resource elements 306 within one or more sub-bands or bandwidth parts (BWPs). Thus, a UE generally utilizes only a subset of the resource grid 304. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a scheduling entity, such as a base station (e.g., gNB, eNB, etc.), or may be self-scheduled by a UE implementing D2D sidelink communication.

In this illustration, the RB 308 is shown as occupying less than the entire bandwidth of the subframe 302, with some subcarriers illustrated above and below the RB 308. In a given implementation, the subframe 302 may have a bandwidth corresponding to any number of one or more RBs 308. Further, in this illustration, the RB 308 is shown as occupying less than the entire duration of the subframe 302, although this is merely one possible example.

Each 1 ms subframe 302 may consist of one or multiple adjacent slots. In the example shown in FIG. 3, one subframe 302 includes four slots 310, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of one of the slots 310 illustrates the slot 310 including a control region 312 and a data region 314. In general, the control region 312 may carry control channels, and the data region 314 may carry data channels. Of course, a slot may contain all DL, all UL, or at least one DL portion and at least one UL portion. The structure illustrated in FIG. 3 is merely an example, and different slot structures may be utilized, and may include one or more of each of the control region(s) and data region(s).

Although not illustrated in FIG. 3, the various REs 306 within an RB 308 may be scheduled to carry one or more physical channels, including control channels, shared channels, data channels, etc. Other REs 306 within the RB 308 may also carry pilots or reference signals. These pilots or reference signals may provide for a receiving device to perform channel estimation of the corresponding channel, which may enable coherent demodulation/detection of the control and/or data channels within the RB 308.

In some examples, the slot 310 may be utilized for broadcast, multicast, groupcast, or unicast communication. For example, a broadcast, multicast, or groupcast communication may refer to a point-to-multipoint transmission by one device (e.g., a base station, UE, or other similar device) to other devices. Here, a broadcast communication is delivered to all devices, whereas a multicast or groupcast communication is delivered to multiple intended recipient devices. A unicast communication may refer to a point-to-point transmission by a one device to a single other device.

In an example of cellular communication over a cellular carrier via a Uu interface, for a DL transmission, the scheduling entity (e.g., a base station) may allocate one or more REs 306 (e.g., within the control region 312) to carry DL control information including one or more DL control channels, such as a physical downlink control channel (PDCCH), to one or more scheduled entities (e.g., UEs). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry hybrid automatic repeat request (HARQ) feedback transmissions such as an acknowledgment (ACK) or negative acknowledgment (NACK). HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc.

The base station may further allocate one or more REs 306 (e.g., in the control region 312 or the data region 314) to carry other DL signals, such as a demodulation reference signal (DMRS); a phase-tracking reference signal (PT-RS); a channel state information (CSI) reference signal (CSI-RS); and a synchronization signal block (SSB). SSBs may be broadcast at regular intervals based on a periodicity (e.g., 5, 10, 20, 30, 80, or 130 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType 1 (SIB1) that may include various additional (remaining) system information. The MIB and SIB1 together provide the minimum system information (SI) for initial access. Examples of system information transmitted in the MIB may include, but are not limited to, a subcarrier spacing (e.g., default downlink numerology), system frame number, a configuration of a PDCCH control resource set (CORESET) (e.g., PDCCH CORESET0), a cell barred indicator, a cell reselection indicator, a raster offset, and a search space (SS) for SIB1. Examples of remaining minimum system information (RMSI) transmitted in the SIB1 may include, but are not limited to, a random access search space, a paging search space, downlink configuration information, and uplink configuration information. A base station may transmit other system information (OSI) as well.

In an UL transmission, the scheduled entity (e.g., UE) may utilize one or more REs 306 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), i.e., request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), such as a CSI report, or any other suitable UCI.

In addition to control information, one or more REs 306 (e.g., within the data region 314) may be allocated for data traffic. Such data traffic may be carried on one or more traffic channels, such as, for a DL transmission, a physical downlink shared channel (PDSCH); or for an UL transmission, a physical uplink shared channel (PUSCH). In some examples, one or more REs 306 within the data region 314 may be configured to carry other signals, such as one or more SIBs and DMRSs.

In an example of sidelink communication over a sidelink carrier via a proximity service (ProSe) PC5 interface, the control region 312 of the slot 310 may include a physical sidelink control channel (PSCCH) including sidelink control information (SCI) transmitted by an initiating (transmitting) sidelink device (e.g., a transmitting (Tx) V2X device or other Tx UE) towards a set of one or more other receiving sidelink devices (e.g., a receiving (Rx) V2X device or some other Rx UE). The data region 314 of the slot 310 may include a physical sidelink shared channel (PSSCH) including sidelink data traffic transmitted by the initiating (transmitting) sidelink device within resources reserved over the sidelink carrier by the transmitting sidelink device via the SCI. Other information may further be transmitted over various REs 306 within slot 310. For example, HARQ feedback information may be transmitted in a physical sidelink feedback channel (PSFCH) within the slot 310 from the receiving sidelink device to the transmitting sidelink device. In addition, one or more reference signals, such as a sidelink SSB, a sidelink CSI-RS, a sidelink SRS, and/or a sidelink positioning reference signal (PRS) may be transmitted within the slot 310.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

The channels or carriers described above with reference to FIGS. 1-3 are not necessarily all of the channels or carriers that may be utilized between a scheduling entity and scheduled entities, and those of ordinary skill in the art will recognize that other channels or carriers may be utilized in addition to those illustrated, such as other traffic, control, and feedback channels.

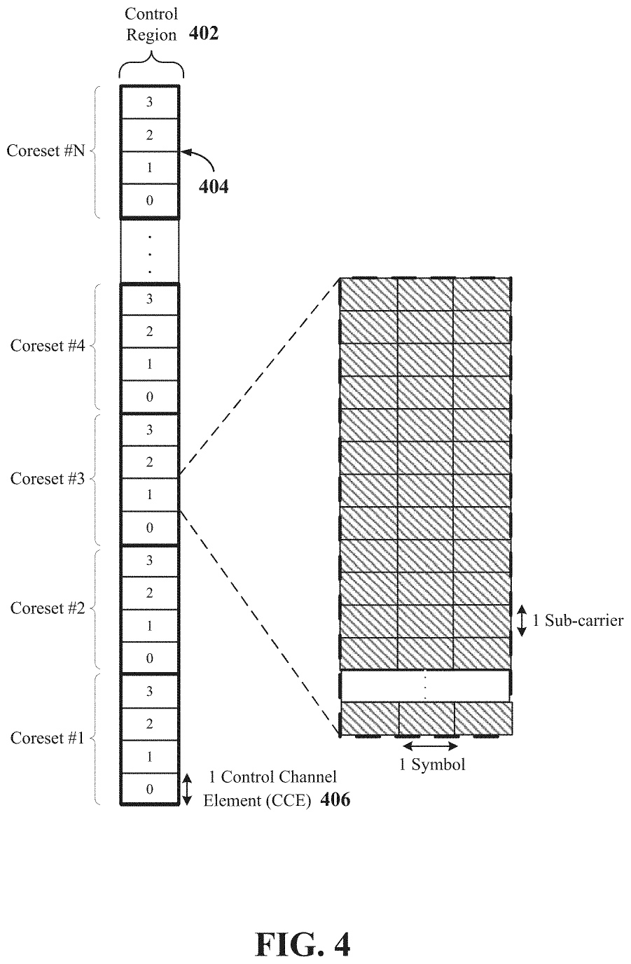

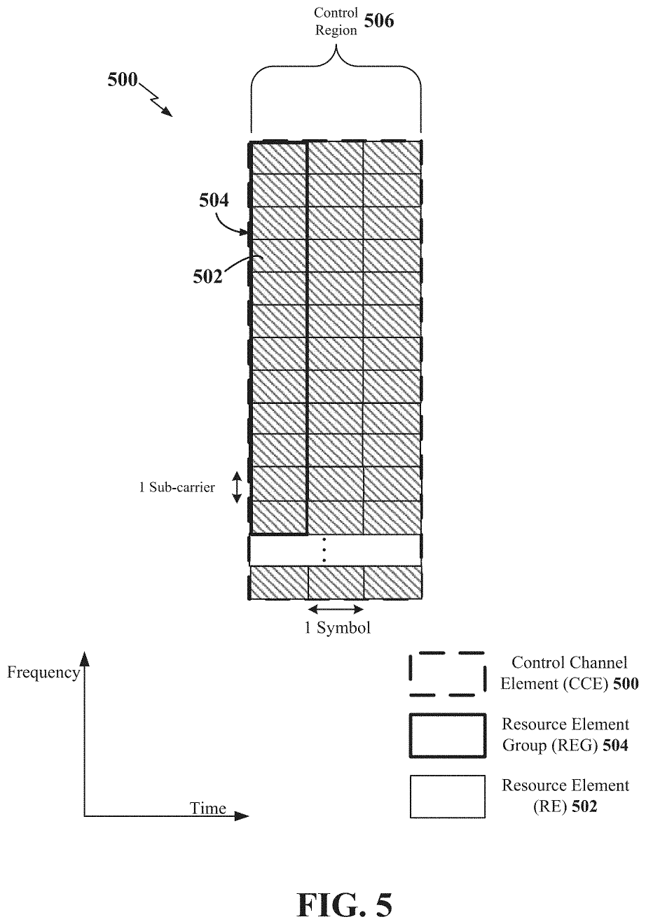

As mentioned above, a base station may use a downlink control region of a slot to send PDCCH information to a UE. In some examples, the PDCCH information may be a scheduling DCI that schedules a downlink transmission to a UE, a scheduling DCI that schedules an uplink transmission by a UE, or a scheduling DCI that schedules some other transmission. In some examples, the PDCCH information may be a non-scheduling DCI (e.g., a DCI that carries information, but does not schedule a transmission). FIGS. 4 and 5 describe example resource configurations that may be used to carry such PDCCH information.

FIG. 4 is a schematic illustration of an example of a downlink (DL) control region 402 of a slot according to some aspects. The DL control region 402 may correspond, for example, to the control region 312 of the slot 310 illustrated in FIG. 3. As discussed above, the DL control region 402 may carry a PDCCH that includes one or more DCIs.

The DL control region 402 includes a plurality of CORESETs 404 indexed as CORESET #1-CORESET #N. Each CORESET 404 includes a number of sub-carriers in the frequency domain and one or more symbols in the time domain. In the example of FIG. 4, each CORESET 404 includes at least one control channel element (CCE) 406 having dimensions in both frequency and time, sized to span across at least three OFDM symbols. A CORESET 404 having a size that spans across two or more OFDM symbols may be beneficial for use over a relatively small system bandwidth (e.g., 5 MHz). However, a one-symbol CORESET may be used in some scenarios.

In some examples, a base station may configure a CORESET 404 for carrying group common control information or UE-specific control information, whereby the CORESET 404 may be used for transmission of a PDCCH including the group common control information or the UE-specific control information to one or more UEs. Each UE may be configured to monitor one or more CORESETs 404 for the UE-specific or group common control information (e.g., on a PDCCH).

In some examples, the PDCCH may be constructed from a variable number of CCEs, depending on the PDCCH format (e.g., aggregation level). Each PDCCH format (e.g., aggregation level) supports a different DCI length. In some examples, PDCCH aggregation levels of 1, 2, 4, 8, and 16 may be supported, corresponding to 1, 2, 4, 8, or 16 contiguous CCEs, respectively.

FIG. 5 is a schematic illustration of an example of a CCE structure 500 in a DL control region 506 of a slot according to some aspects. The DL control region 506 may correspond, for example, to the control region 312 of the slot 310 illustrated in FIG. 3. The CCE structure 500 includes a number of REs 502 that may be grouped into at least one RE group (REG) 504. Each REG 504 generally may contain, for example, twelve consecutive REs 502 (or nine REs 502 and three DMRS REs) within the same OFDM symbol and the same RB. In the example of FIG. 5, the CCE structure 500 includes at least six REGs 504 (not shown in their entirety) distributed across three OFDM symbols. However, as those skilled in the art will readily appreciate, the CCE structure 500 for any particular application may vary from the example described herein, depending on any number of factors. For example, the CCE structure 500 may contain any suitable number of REGs.

In some examples, a UE may be unaware of the particular aggregation level of the PDCCH or whether multiple PDCCHs may exist for the UE in the slot. Consequently, the UE may perform blind decoding of various PDCCH candidates within the first N control OFDM symbols of the slot (as indicated by the slot format of the slot) and/or other OFDM symbols of the slot. In some examples, this decoding is based on a radio network temporary identifier (RNTI) (e.g., a UE-specific RNTI or a group RNTI) that the base station is expected to use when encoding the PDCCH. Each PDCCH candidate includes a collection of one or more consecutive CCEs based on an assumed DC1 length (e.g., PDCCH aggregation level). The term PDCCH candidate is used here to emphasize that the UE might not be configured with information indicating exactly what type of PDCCH is carried within a slot or where a particular PDCCH is carried within a slot. Thus, with blind decoding, the UE attempts to decode signals received on different sets of resource (e.g., corresponding to different PDCCH candidates) to determine whether those resources are actually carrying a PDCCH.

To limit the number of blind decodes performed by a UE, a base station may configure certain search spaces such as UE-specific search spaces (USSs) and common search spaces (CSSs). Here, the base station may send a PDCCH to a UE or a set of UEs only on the resources specified for the configured search space(s). Thus, the UE or UEs may limit their blind decoding to the configured search space(s). In some examples, the base station may configure one or more search space sets, each of which includes at least one search space. In some examples, different search space sets may be assigned different search space set identifiers (IDs). In some examples, a search space set ID may be referred to as a search space set index.

A UE-specific search space sets consist of CCEs used for sending control information to a particular UE. The starting point (offset or index) of a UE-specific search space may be different for each UE. In addition, each UE may have multiple UE-specific search spaces (e.g., one for each aggregation level).

A common search space sets consist of CCEs used for sending control information that is common to a group of UEs or to all UEs (e.g., under a given cell). Thus, the common search space sets are monitored by multiple UEs in a cell. The starting point (offset or index) of a search space set for group common control information may be the same for all UEs in the group and there may be multiple search space sets defined for group common control information (e.g., one for each configured aggregation level for the group of UEs).

A UE may perform blind decoding over all aggregation levels and corresponding USSs or CSSs to determine whether at least one valid DCI is carried by the UE-specific search space (USS) or the common search space (CSS) for the UE. By using search space sets (e.g., USSs and CSSs) configured for a UE for this blind decoding, the number of blind decodes that the UE performs for each PDCCH format combination may be reduced (e.g., as compared to a scenario that does not use search space sets).

A UE may monitor a search space for downlink assignments and uplink grants relating to a particular component carrier for the UE. For example, the UE may monitor the search space for a PDCCH that includes a DCI that schedules a PDSCH in the same slot or in a different slot for that component carrier. In this case, the DCI includes a frequency domain resource assignment and a time domain resource assignment for a PDSCH and other information (e.g., MCS etc.) that enables the UE to decode the PDSCH.

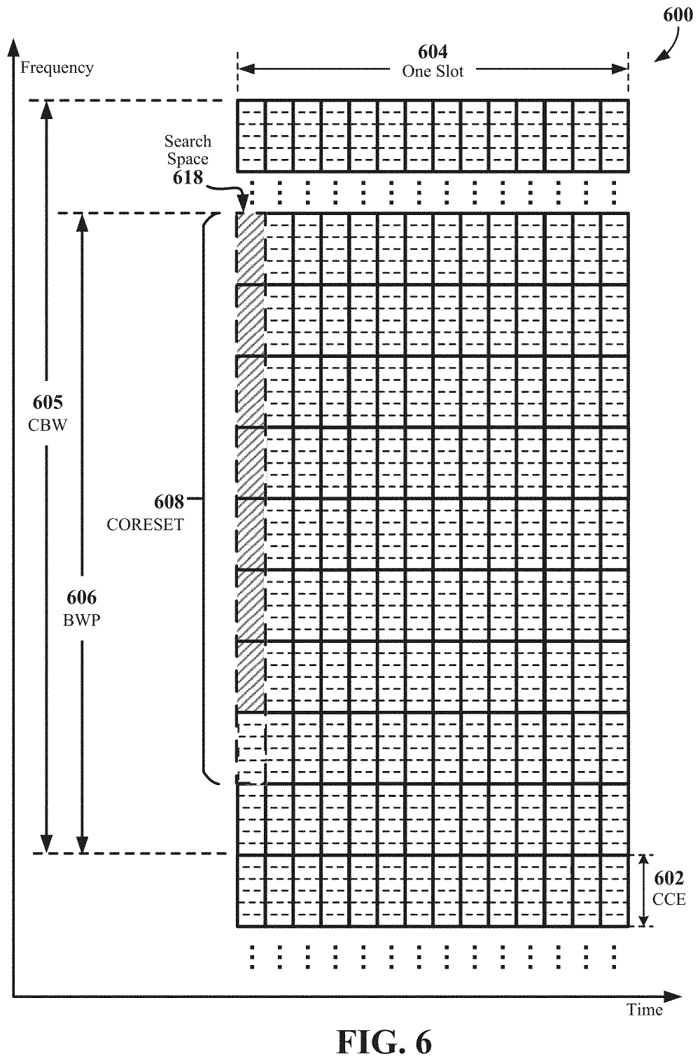

FIG. 6 is a schematic illustration of an example of downlink time-frequency resources 600, where a search space is defined within a CORESET. In FIG. 6, time is in the horizontal direction with units of OFDM symbols and frequency is in the vertical direction with units of CCEs. For example, the vertical dimension of each major solid line rectangle represents one CCE 602. Each CCE 602 includes 6 resource element groups (REGs). Each REG may correspond to one physical resource block (PRB), including 12 resource elements (REs) in the frequency domain and one OFDM symbol in the time domain. The 6 REGs of each CCE 602 are respectively represented by a minor dashed line rectangle. One slot 604 in the time domain is represented. Other resource configurations may be used in other examples.

FIG. 6 depicts one bandwidth part (BWP) 606 within a carrier bandwidth (CBW) 605. According to some aspects, the BWP 606 is a contiguous set of physical resource blocks (PRBs) on a given carrier. In the example of FIG. 6, the contiguous set of PRBs are represented by a contiguous set of CCEs 602. In addition, the BWP 606 corresponds to a set of 64 PRBs, which represent 648 subcarriers (i.e., 12 REs/REG×6 REGs/CCE×9 CCEs). A base station may configure different sets of these CCEs as common CCEs or UE-specific CCEs.

In the example of FIG. 6, a CORESET 608 includes 48 REGs in one set of eight CCEs (where each CCE may be similar to CCE 602). The eight CCEs may be grouped as a first DCI.

A CORESET may include a one or more search spaces. A search space may include all or a portion of a CORESET. A CORESET may be associated with a common search space, a UE-specific search space, or a combination of both. In the example of FIG. 6, one search space (SS) 618 is indicated for the CORESET 608 (represented by the slanted lines).

A search space may include a number of PDCCH candidates. As mentioned above, a UE may attempt to blind decode a PDCCH candidate in each search space; even if a base station did not schedule a PDCCH in any given search space.

The following relationships between CORESETs, BWPs, and search spaces are made with reference to some examples of NR; however, the following is exemplary and non-limiting and other relationships between CORESETs, BWPs, and search spaces (or their equivalents, for example in other radio technologies) are within the scope of the disclosure. In some examples, for a given UE, a base station may configure up to three CORESETs in a BWP of a serving cell (e.g., a component carrier (CC)), including both common and UE-specific CORESETs. In addition, the base station may configure up to four BWPs per serving cell, with one of the BWPs active at a given time. Accordingly, a maximum number of CORESETs for a UE per serving cell may be twelve (e.g., 3 CORESETs per BWP×4 BWPs per serving cell) in these examples. The resource elements of a CORESET may be mapped to one or more CCEs. One or more CCEs from one CORESET may be aggregated to form the resources used by one PDCCH. In some examples, the maximum number of search spaces per BWP may be ten (10). In some examples, multiple search spaces may use the time-frequency resources of one CORESET.

A base station may send a PDCCH to a UE via the downlink time-frequency resources 600 (e.g., within a configured search space). In some examples, the base station may compute a cyclic redundancy check (CRC) of a payload of a DCI carried by a PDCCH. The CRC may be scrambled using an identifier of a UE. An example of such an identifier may be a radio network temporary identifier (RNTI), such as a random access-radio network temporary identifier (RA-RNTI).

During blind decoding of a search space, the UE may attempt to descramble CRC of a PDCCH candidate using the RNTI. For example, the UE may compute a CRC on the payload of the corresponding DCI using the same procedure as used by the base station, and then compare the CRCs. If the CRCs are equal, the DCI was destined for the UE. If the payload was corrupted or the CRC was scrambled using another UE's RNTI, then the CRCs would not match, and the UE may disregard the DCI.

A UE under the coverage area of a RAN may operate in one of several defined operating states (also referred to as modes). In some examples, these states include an idle state, an inactive state, and a connected state. In 5G NR, these operating states may be defined as radio resource control (RRC) states: RRC_IDLE, RRC_INACTIVE, and RRC_CONNECTED.

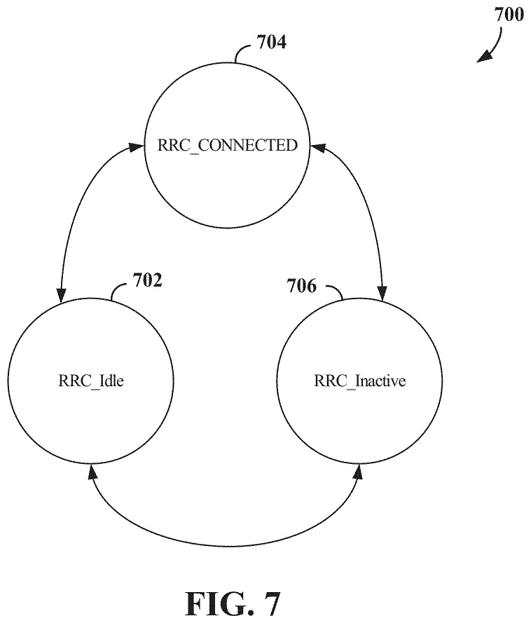

FIG. 7 illustrates an example of a state transition diagram 700 for these RRC states. A UE will be in an idle state (e.g., RRC_IDLE 702) when it first powers up. The UE may transition to a connected state (e.g., RRC_CONNECTED 704) with a RAN (e.g., with a base station of the RAN) by performing a random access procedure with that RAN. In the connected state, the UE may communicate with the RAN via dedicated signaling (e.g., dedicated channels). A UE may switch to idle state or inactive state (e.g., RRC_INACTIVE 706) under certain circumstances. For example, a UE that does not have data to send to the RAN and that is not receiving data from the RAN may elect to switch to the idle state or the inactive state to conserve battery power. In these states, since the UE is not actively communicating with the RAN, the UE may power off some of its components (e.g., radio components). That is, the UE enters a lower power state.

The UE will periodically wake up from the low power state to monitor for signaling from the RAN (e.g., to determine whether the RAN has data to send to the UE). In some examples, this periodicity may be based on a discontinuous reception (DRX) cycle specified by the RAN.

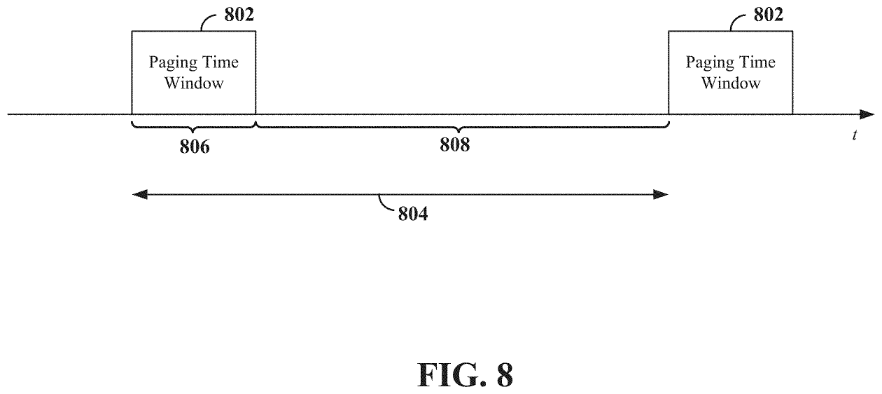

FIG. 8 illustrates an example 800 of such a DRX cycle where paging time windows 802 are separated in time according to a DRX cycle period 804. In this example, each paging time window 802 corresponds to a time period 806 during which time the UE wakes up from the lower power state to receive paging messages from the RAN (e.g., from a base station of the RAN). If the RAN has data to send to the UE or if the RAN needs to communicate with the UE for other reasons, the RAN will page the UE according to the DRX cycle (i.e., during the paging time windows 802 when the UE periodically wakes up from the lower power state). The RAN sends a paging message via a paging channel (e.g., via a paging frame). In addition, the RAN may define different paging opportunities that can be used by different UEs to receive a paging message. That is, UEs remain in the lower power state (e.g., during the time period 808) until their own paging opportunities occur. The use of different paging opportunities for different UEs allows the RAN to direct paging to a particular UE or a small subset of UEs. This reduces the likelihood that a UE will need to expend battery power to process paging that is directed to another UE. Upon receiving a paging message indicating that the network will be sending data (or other information) that a UE needs to receive, the UE may resume full operations (e.g., turn on all radio components) and, if needed, reestablish a connected state with the RAN.

In some scenarios, traffic between a base station (e.g., a gNB) and a UE may be periodic (e.g., strictly periodic or quasi-periodic). For example, cross reality (XR) and cloud gaming downlink traffic may use advanced video coding such as H.264/H.265 encoded video. In this case, the downlink traffic may be quasi-periodic with a burst every frame @1/frame per second (fps) or two possibly staggered “eye-buffers” per frame @1/(2*fps). The uplink traffic for cloud gaining includes controller information, and the uplink traffic for virtual reality (VR) split rendering includes controller information and user pose information. Here, the periodicity may be reduced so that it aligns with the downlink traffic. To provide low-latency, the UE is preferably scheduled as soon as a new burst of data is available for transmission. Conversely, to provide power savings, the UE is preferably allowed to enter a sleep mode as long as possible in between the transmissions of the downlink data bursts.

Search Space Set Grouping (SSSG) switching may be used to reduce UE power consumption in some scenarios. In some examples, a UE is configured with two SSSGs. A first SSSG (SSSG#1) may be defined for a UE to use to monitor for PDCCH traffic. For example, a UE may be configured to use SSSG#1 when there is PDCCH traffic for the UE. A second SSSG (SSSG#2) may be defined for when the UE is not monitoring PDCCH traffic. For example, when there is no PDCCH traffic for the UE, the UE may be configured to switch from SSSG#1 to SSSG#2. The UE may thus enter sleep mode (e.g., a low power state), and thereby conserve the battery power of the UE.

A switch from SSSG#1 to SSSG#2 may be signaled by the base station through a specific parameter (e.g., a Switch Request) sent via downlink control information (DCI). In some examples, a switch from SSSG#2 to SSSG#1 may be controlled by a timer SSSG2_Timer), which may be configured by the base station through RRC signaling. For example, when the UE switches from SSSG#1 to SSSG#2, the UE may start SSSG2_Timer and, when this timer expires, the UE may switch back to SSSG#1.

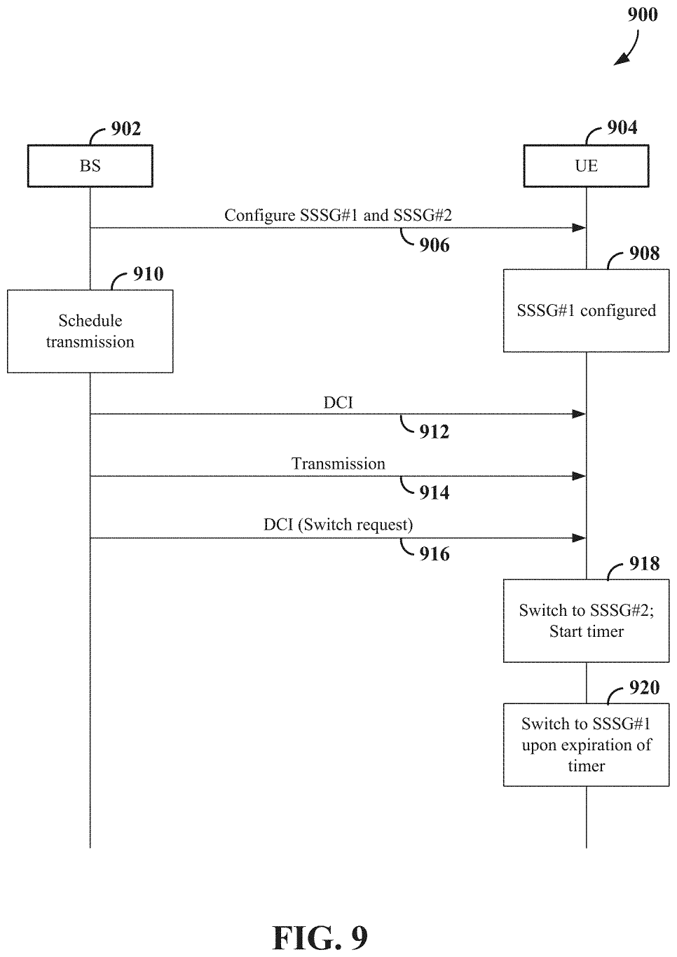

FIG. 9 is a signaling diagram 900 illustrating an example of SSSG switching-related signaling in a wireless communication system including a base station (BS) 902 and a user equipment (UE) 904. In some examples, the BS 902 may correspond to any of the base stations or scheduling entities shown in any of FIGS. 1, 2, 13, 14, and 18. In some examples, the UE 904 may correspond to any of the UEs or scheduled entities shown in any of FIGS. 1, 2, 13, 14, and 15.

At it 906 of FIG. 9, the BS 902 transmits configuration information to the UE 904 to configure a first SSSG (SSSG#1) and a second SSSG (SSSG#2). In some examples, the BS 902 transmits this configuration information via RRC signaling.

At #908, the UE 904 initially is configured for the first SSSG. Thus, the UE 904 may monitor for PDCCH transmissions by the BS 902.

At #910, the BS 902 schedules a transmission to the UE 904. Accordingly, the BS 902 transmits a scheduling DCI to the UE 904 at #912 and transmits the scheduled transmission at #914. As discussed herein, this transmission may be a data burst of a periodic transmission.

At #916, at the end of the transmission of #914, the BS 902 transmits a DCI including an SSSG switch request to the UE 904.

At #918, in response to the SSSG switch request, the UE 904 switches to SSSG#2 and starts a timer. Here, the UE 904 may enter a low power mode to conserve battery power.

At #920, the UE 904 switches back to SSSG#1 upon expiration of the timer. Thus, the UE 904 may again monitor a downlink channel in conjunction with receiving the next transmission (e.g., the next data burst) from the BS 902.

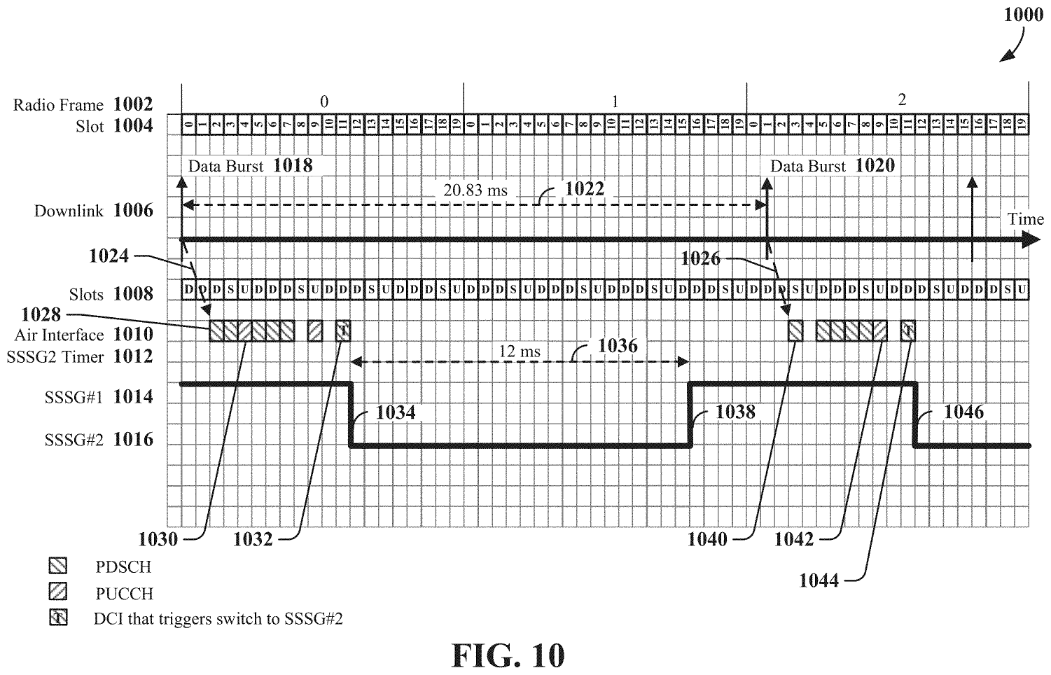

FIG. 10 illustrates an example of a timing diagram 1000 for SSSG switching. The timing diagram 1000 has a ‘DDDSU’ frame structure for TDD, with a subcarrier spacing (SCS)=30 kHz and a 48 Hz traffic cadence in some examples. With this periodic traffic, when the transmission of a data burst is done (e.g., when the last symbol of the transmission has been sent), the base station requests the UE to switch to SSSG#2. The SSSG2_Timer is configured such that the UE switches back to SSSG#1 when the next data burst is available for transmission.

The timing diagram 1000 illustrates several radio frames 1002, each of which includes 20 slots 1004. Here, downlink transmissions 1006 occur periodically as represented by a first data burst 1018 and a second data burst 1020 at a periodicity 1022 (e.g., a 20.83 ms periodicity). The ‘DDDSU’ frame structure is indicates by slots 1008, where D refers to a downlink slot, S refers to a special slot, and U refers to an uplink slot. Transmissions for the data bursts over the air interface 1010 are indicated for corresponding slots. An SSSG2 timer 1012 is also indicated by the time during which a UE is configured for SSSG#1 1014 and the time during which the UE is configured for SSSG#2 1016. For example, the UE is configured for SSSG#2 1016 for a period of time 1036 (e.g., 12 ms).

PDSCH transmissions for the first data burst 1018 are indicated by a first set of hashed boxes (e.g., in slot 1028), while PUCCH transmissions for the first data burst 1018 are indicated by a second set of hashed boxes (e.g., in slot 1030). In addition, a slot 1032 for the first data burst 1018 carries a DCI that triggers a switch 1034 by a UE to SSSG#2, which may result in the UE entering a low power mode.

At the end of the period of time 1036 (e.g., upon expiration of the SSSG#2 timer), the UE conducts a switch 1038 back to SSSG#1. Thus, the UE may exit the low power mode and recommence monitoring for PDSCH transmissions from the base station.

PDSCH transmissions for the second data burst 1020 are indicated by a first set of hashed boxes (e.g., in slot 1040), while PUCCH transmissions for the first data burst 1018 are indicated by a second set of hashed boxes (e.g., in slot 1042). In addition, a slot 1044 for the second data burst 1020 carries a DCI that triggers a switch 1046 to SSSG#2.

The timing diagram 1000 also shows that there may be some delay (e.g., delay 1024 and delay 1026) between the transmission of a data burst by a base station and the receipt of the data burst by a UE.

Preferably, the UE will switch back to SSSG#1 just in time for the transmission of the next data burst. If the UE switches back too early, then until the next data burst, the UE will be monitoring the downlink channel(s) when it could have been in sleep mode instead, which needlessly it creases the UE power consumption. Conversely, if the UE switches back too late, then for the next data burst, the base station has to wait for the UE to switch back to SSSG#1 to start the transmission, and this negatively impacts the latency of the transmission. A preferred value of the SSSG2_Timer may be the time between the transmission of the DCI with the Switch Request and the start of the transmission of the next data burst (assuming that the traffic suffers from no jitter). In this case, the UE would switch back to SSSG#1 just before the slot 1040.

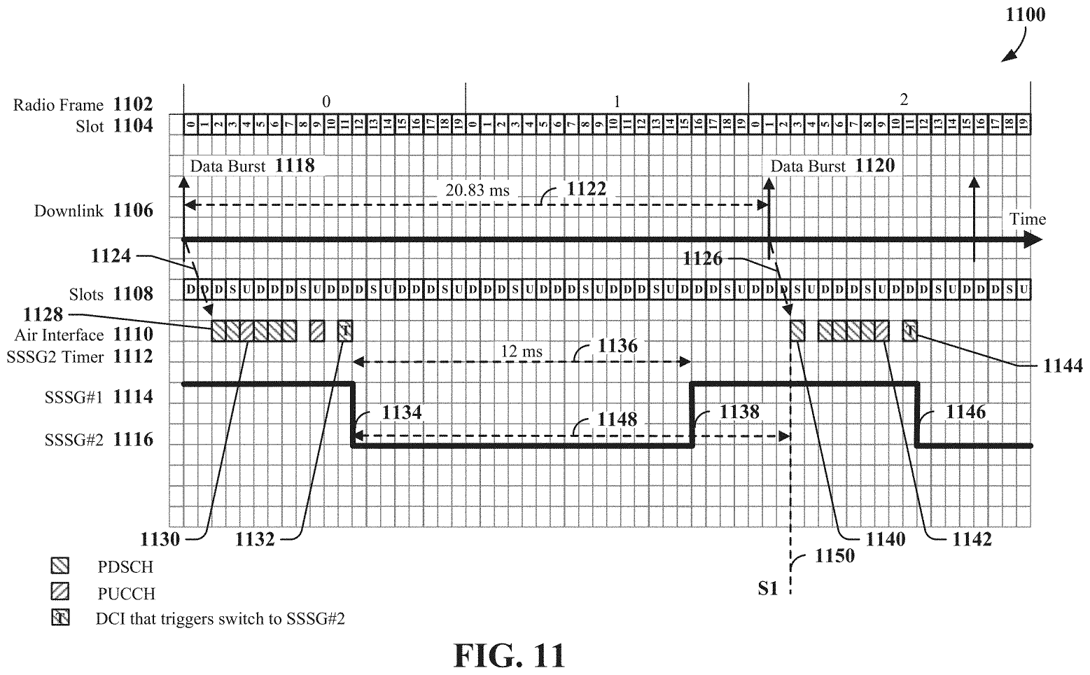

FIG. 11 illustrates an example of a timing diagram 1100 for SSSG switching similar to the timing diagram 1000 of FIG. 10. The radio frames 1102, slots 1104, downlink transmissions 1106, slots 1108, air interface 1110, SSSG2 timer 1112, SSSG#1 1114, SSSG#2 1116, first data burst 1118, second data burst 1120, periodicity 1122, delay 1124, delay 1126, slot 1128, slot 1130, slot 1132, switch 1134, period of time 1136, switch 1138, slot 1140, slot 1142, slot 1144, and switch 1146 illustrated in FIG. 11 may be similar to the radio frames 1002, slots 1004, downlink transmissions 1006, slots 1008, air interface 1010, SSSG2 timer 1012, SSSG#1 1014, SSSG#2 1016, first data burst 1018, second data burst 1020, periodicity 1022, delay 1024, delay 1026, slot 1028, slot 1030, slot 1032, switch 1034, period of time 1036, switch 1038, slot 1040 slot 1042, slot 1044, and switch 1046 illustrated in FIG. 10.

The timing diagram 1100 further illustrates an example of a preferred value for the SSSG2_Timer. Here, the period of time 1148 (e.g., corresponding to the preferred value for the SSSG2_Timer) ends at a time S1 1150 corresponding to the beginning of the first slot (e.g., slot 1140) of the second data burst 1120. If this period of time value is used for the SSSG2_Timer, the UE will not switch to SSSG#1 too early. Thus, the UE may better conserve battery power. In addition, the UE will not switch to SSSG#1 too late. Thus, the latency for the downlink transmission will not be longer than necessary.

The arrival time of the data burst may suffer from jitter (e.g., arrival times may be subject to minor deviations). In this case, the base station might not know the actual arrival time of the next burst which may negatively impact the determination of the preferred value of the SSSG2_timer.

The disclosure relates in some aspects to a base station learning the distribution of the jitter around the ideal (no jitter) arrival time and thereby determining a preferred SSSG2_timer value (e.g., determining how much earlier with respect to the preferred arrival time the UE should switch back to SSSG#1).

In some aspects, the amount of time the UE should switch back to SSSG#1 ahead of the preferred arrival time may be a tradeoff between latency and power saving. If the UE switches back to SSSG#1 early, it is less likely that the base station will have to wait before starting the corresponding transmission. This improves the latency, but at the expense of power saving. Conversely, if the UE switches back to SSSG#1 at a later time, this improves the power saving, but the base station may have to wait before starting the corresponding transmission, thereby increasing the latency.

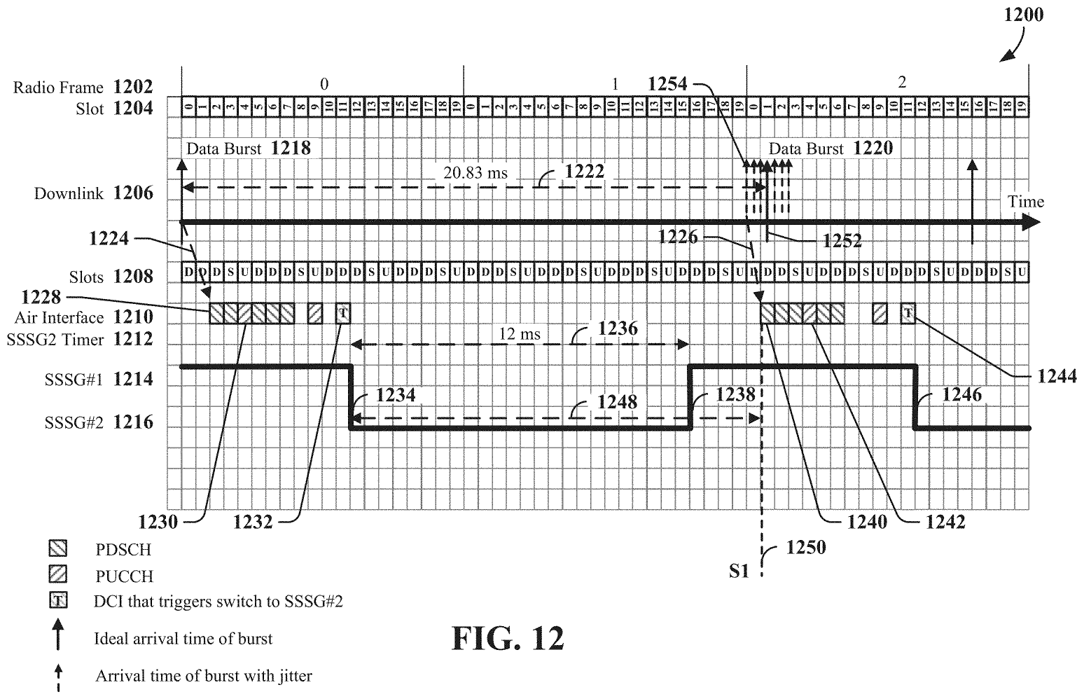

FIG. 12 illustrates an example of a timing diagram 1200 for SSSG switching similar to the timing diagram 1100 of FIG. 11, showing the scenario where the traffic suffers from jitter. The radio frames 1202, slots 1204, downlink transmissions 1206, slots 1208, air interface 1210, SSSG2 timer 1212, SSSG#1 1214, SSSG#2 1216, first data burst 1218, second data burst 1220, periodicity 1222, delay 1224, delay 1226, slot 1228, slot 1230, slot 1232, switch 1234, period of time 1236, switch 1238, slot 1240, slot 1242, slot 1244, switch 1246, period of time 1248, and time S1 1250 illustrated in FIG. 12 may be similar to the radio frames 1102, slots 1104, downlink transmissions 1106, slots 1108, air interface 1110, SSSG2 timer 1112, SSSG#1 1114, SSSG#2 1116, first data burst 1118, second data burst 1120, periodicity 1122, delay 1124, delay 1126, slot 1128, slot 1130, slot 1132, switch 1134, period of time 1136, switch 1138, slot 1140, slot 1142, slot 1144, switch 1146, period of time 1148, and time S1 1150 illustrated in FIG. 11.

In FIG. 12, the preferred arrival time of the burst is represented by the arrow 1252. However, the actual arrival time of the burst is subject to jitter as represented by the corresponding dashed arrows (e.g., the arrow 1254). In this case, the base station may determine the distribution of the jitter and thereby determine that the UE should switch back to SSSG#1 at the time S1 1250.

In practice, the time between the transmission of the DCI with the “Switch Request” at slot 1232 and the time S1 1250 may change (e.g., may be subject to jitter). This timing may depend on several factors. One such factor may be the current radio conditions. For example, the number of MAC PDUs required to transmit a data burst may depend on various metrics, which may be determined from a signal to noise ratio (SNR). Examples of such metrics include the MCS, and the number of MIMO layers. Another factor may be the applicable scheduling policies. For example, the number of MAC PDUs may depend on the number of RBs being allocated, which is under the scheduler control. However, the scheduler may or may not transmit a data burst in consecutive slots. For example, if several UEs are being served by a cell, the scheduler for that cell may elect to multiplex resources for these UEs in the time domain. Another factor affecting timing may be the number of HARQ retransmissions. For example, more HARQ retransmissions may require more slots.

In view of the above, the use of a single value for the SSSG2_Timer may not adequately address the dynamic nature of the transmissions, provide sufficient power savings, and meet latency requirements.

The disclosure relates in some aspects to dynamically changing the value of SSSG2_Timer. For example, when the transmission of a data burst is completed, the base station may evaluate the remaining time until the next time S1. For example, the base station may be able to do such an evaluation for quasi-periodic traffic (e.g., XR traffic). In some examples, the base station may determine the remaining time based on the corresponding QoS parameters. In some examples, the base station may determine the remaining time by learning the arrival time of downlink data in its transmission buffers and the jitter that may apply. In some examples, the base station may determine the remaining time by making use of information received from the UE about the arrival time of uplink data in the UE's transmission buffer.

From the remaining time, the base station may determine a suitable value of the SSSG2_Timer. This value might not be exactly the remaining time, as it may depend on, for example, the base station's algorithm and implementation constraints and/or the time it takes to signal the value of the SSSG2_Timer to the UE.

In some examples, the base station signals the newly determined value of the SSSG2_Timer to the UE if this new value is different from the latest previously signaled value. Thus, if the values are not different, the base station may elect to not signal the newly determined value, thereby reducing signaling overhead.

The disclosure relates in some aspects to signaling multiple values for a dynamic SSSG2_Timer. In some examples, absolute timer values and/or relative timer values may be signaled. For example, a base station may dynamically send to a UE the timer value that the UE should currently use. Alternatively, or in addition, the base station may dynamically send to the UE a delta (e.g., an increase step or a decrease step) that the UE should use to adjust the timer value that the UE is currently using.

When absolute timer values are used, a base station and a UE may make use of a list of the possible absolute values for the SSSG2_Timer. In this case, the base station may signal to the UE the particular absolute timer value to be used (e.g., an index to that value in the list).

When relative timer values are used, a base station and a UE may make use of a list of steps by which the value currently in use can be increased or decreased. In this case, the base station may signal to the UE the particular relative timer value to be used (e.g., an index to that step value in the list).

For the example where the base station and the UE make use of a list of the possible values of the SSSG2_Timer, when the traffic is being setup, the base station may determine a list of possible values of the SSSG2_Timer. The values may depend on several factors, such as the XR traffic characteristics (e.g., period), the cell configuration (e.g., frequency, bandwidth . . . ), the number of UEs in the cell, the base station's algorithm and implementation constraints, or a combination thereof. In some examples, the base station configures the UE with this list through RRC signaling. The base station may also signal which of the values the UE shall start using. When the transmission of a data burst is done (or at some other suitable time), the base station may evaluate the remaining time until the next data burst and thereby determine the value of the SSSG2_Timer that suits this remaining time. If the new value of SSSG2_Timer is different from the one currently in use by the UE, the base station may signal the new value to the UE.

When a list of SSSG2_Timer values is used, the input criteria used when the list seas built may change afterwards (e.g., a change of the number of UEs in the cell may impact the base station's scheduling policies). Thus, the initial list of values might not always be the preferred values.

The disclosure relates in some aspect to increasing or decreasing the value of SSSG2_Timer through configurable steps. In some aspects, this techniques may be better suited for dynamic scenarios (e.g., where a preconfigured list might not be preferred as discussed above).

For the example where the base station and the UE make use of a list of steps by which the value currently in use can be increased or decreased, when the traffic is being setup, the base station may determine a list of steps. In some examples, the list may take the form {−2; −1; +1; +2}. Here, each step represents a number of time units (e.g., slots, milliseconds, etc.) to increase or to decrease the SSSG2_Timer. For example, a step value of ‘−2’ may mean that the SSSG2_Timer is to be decreased by 2. time units. Other lists may be used in other examples. In some examples, the base station configures the UE with the list of steps through RRC signaling. When the transmission of a data burst is done or at some other suitable time), the base station may evaluate the remaining time until the next data burst. From the remaining time, the base station may determine whether the current value of SSSG2_Timer needs to be changed and the step to be applied. If the value of SSSG2_Timer needs to be increased or decreased, the gNB signals the new value to the UE.

In some examples, a UE may be configured to concurrently use DRX (e.g., enhanced connected mode DRX (ECDRX)) and SSSG switching. In this case, a base station may instruct the UE to switch to SSSG#2 at the next DRX On_Duration period for the UE. Since the start of the next On_Duration period is known to the UE (e.g., via RRC configuration), there is no need for the gNB to signal the duration during which the UE is to stay in SSSG#2 in this case. In some examples, the base station may instruct the UE to switch back to SSSG#1 semi-statically (through RRC signaling) or dynamically (e.g., through a specific codepoint in the list of values of the SSSG2_Timer).

In some examples, a base station may configure a UE through RRC signaling to switch from SSSG#2 to SSSG#1 at the start of the On_Duration period. In some examples, in addition to absolute and relative values of the SSSG2_Timer, a specific codepoint shall be reserved to signal the start of the next On_Duration period.

In some examples, a base station may signal a new value via dedicated bits in the DCI. For example, the bits of a timer duration field (e.g., Switch Request) of a particular DCI may indicate an absolute timer value, a relative timer value, or the designated codepoint value. Thus, the value that is signaled can be a specific value, the codepoint to the next On_Duration period, or an index into the list that was configured by RRC. As discussed above, the list may be a set of absolute values of the SSSG2_Timer or a list of relative values (e.g., steps).

The base station may signal the new value at various times. For example, the base station may signal the new value in the DCI that triggers the switch to SSSG#2, or in some other DCI. Upon reception of a DCI with a new value, the UE may store this value and use it upon reception of a DCI with the Switch Request to determine when to switch to SSSG#1.

In some examples, a base station may signal the new value via a MAC Control Element (MAC-CE). In some examples, the signaled value may be a specific value, a codepoint to the next On_Duration period, or an index into the list that was configured by RRC signaling. As discussed above, the list may be a set of absolute values of the SSSG2_Timer or a list of relative values (e.g., steps).

The base station may signal the new value at various times. For example, the base station may signal the new value in a MAC CE that is scheduled with the DCI that triggers the switch to SSSG#2, or at any other time. Upon reception of a MAC-CE with a new value, the UE may store this value and use it upon reception of a DCI with the Switch Request to determine when to switch to SSSG#1.

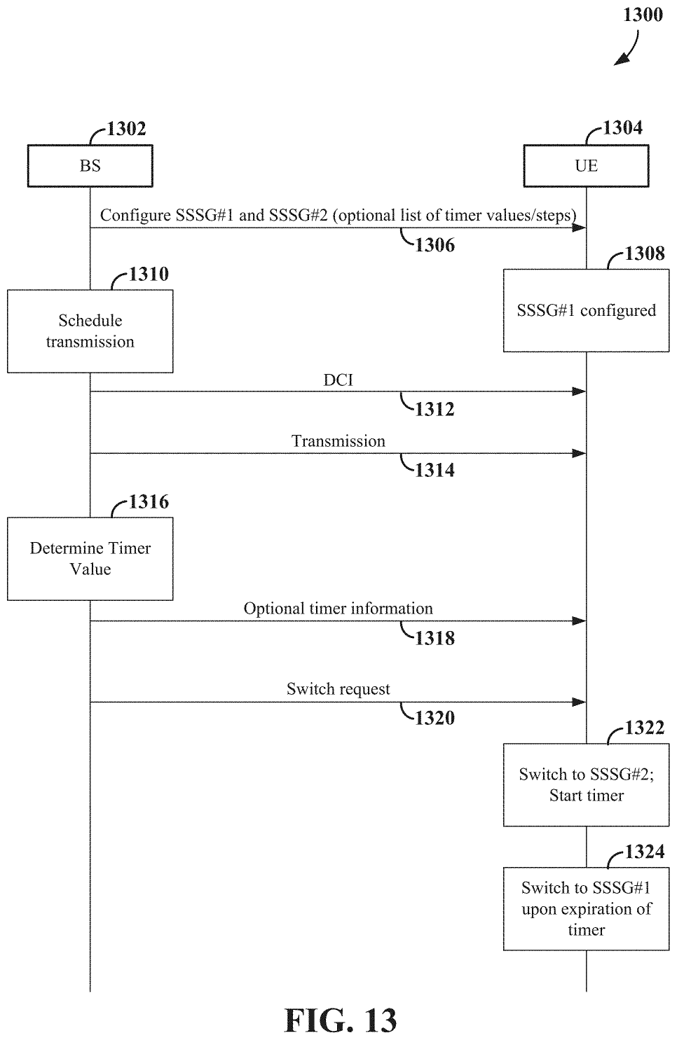

FIG. 13 is a signaling diagram 1300 illustrating an example of SSSG switching-related signaling in a wireless communication system including a base station (BS) 1302 and a user equipment (UE) 1304. In some examples, the BS 1302 may correspond to any of the base stations or scheduling entities shown in any of FIGS. 1, 2, 9, 14, and 18. In some examples, the UE 1304 may correspond to any of the UEs or scheduled entities shown in any of FIGS. 1, 2, 9, 14, and 15.

At #1306 of FIG. 13, the BS 1302 transmits configuration information to the UE 1304 to configure a first SSSG (SSSG#1) and a second SSSG (SSSG#2). In some examples, the configuration information may include a list of absolute timer values and/or a list of relative timer values (e.g., steps) as discussed herein. In some examples, the BS 1302 transmits this configuration information via RRC signaling.

At #1308, the UE 1304 initially is configured for the first SSSG. Thus, the UE 1304 may monitor for downlink (e.g., PDCCH) transmissions by the BS 1302.

At #1310, the BS 1302 schedules a transmission to the UE 1304. Accordingly, the BS 1302 transmits a scheduling DCI to the UE 1304 at #1312 and transmits the scheduled transmission at #1314. As discussed herein, this transmission may be a data burst of a periodic transmission.

At #1316, at the end of the transmission of #1314, the BS 1302 determines a timer value (e.g., an absolute value or a step value) associated with the transmission of #1314. For example, the BS 1302 may estimate the period of time between the time at which the UE 1304 switches to SSSG#2 (at the end of the transmission of #1314) and a preferred time for the UE 1304 to switch back to SSSG#1. If a determined absolute timer value is different from the last absolute timer value sent to the UE 1304 or if a determined step is not zero (0), the BS 1302 sends corresponding timer information (e.g., the absolute timer value, the step value, or an index into a corresponding list) to the UE 1304 at #1318. In some examples, the BS 1402 may transmit this indication in a timer duration bit field of a DCI.

At #1320, the BS 1302 transmits an SSSG switch request to the UE 1304. In some examples, the BS 1302 transmits this SSSG switch request via a DCI. In some examples, this DCI may include the timer information of #1318.

At #1322 (e.g., in response to the SSSG switch request), the UE 1304 switches to SSSG#2 and starts a timer. Here, the UE 1304 may enter a low power mode to conserve battery power.

At #1324, the UE 1304 switches back to SSSG#1 upon expiration of the timer. Thus, the UE 1304 may again monitor one or more downlink channels in conjunction with receiving the next transmission (e.g., the next data burst) from the BS 1302.

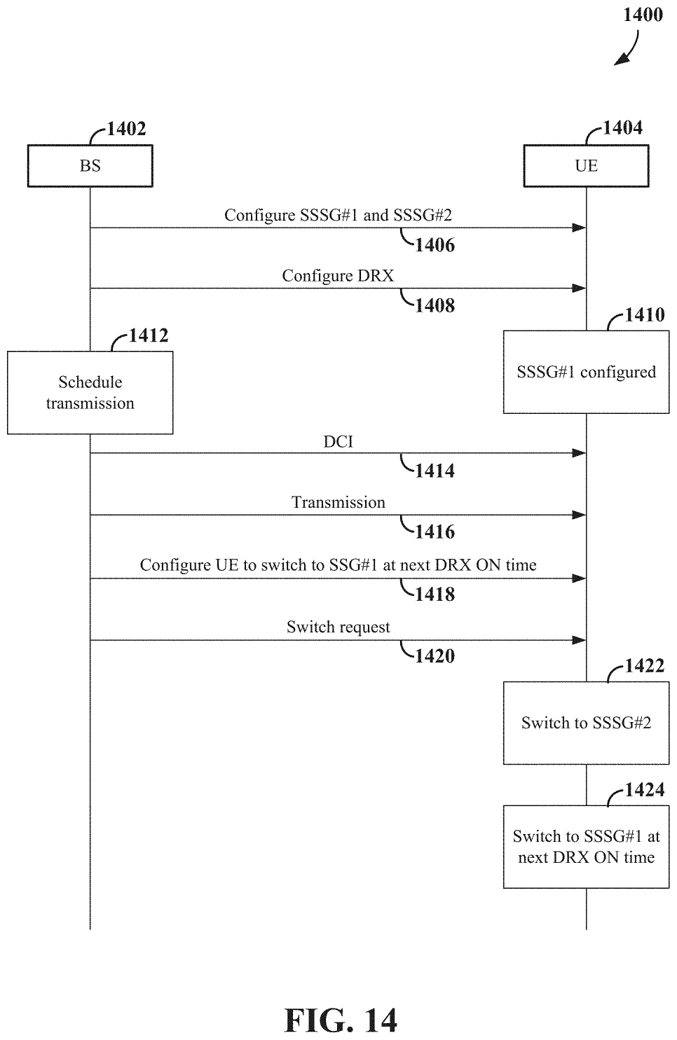

FIG. 14 is a signaling diagram 1400 illustrating another example of SSSG switching-related signaling in a wireless communication system including a base station (BS) 1402 and a user equipment (UE) 1404. In some examples, the BS 1402 may correspond to any of the base stations or scheduling entities shown in any of FIGS. 1, 2, 9, 13, and 18. In some examples, the UE 1404 may correspond to any of the UEs or scheduled entities shown in any of FIGS. 1, 2, 9, 13, and 15.

At #1406 of FIG. 14, the BS 1402 transmits SSSG configuration information to the UE 1404 to configure a first SSSG (SSSG#1) and a second SSSG (SSSG#2). In some examples, the BS 1402 transmits this SSSG configuration information via RRC signaling. This SSSG configuration information may be similar to the configuration information discussed above in conjunction with #1306 of FIG. 13.

At #1408, the BS 1402 transmits DRX configuration information to the UE 1404 to configure at least one DRX cycle for the UE 1404. In some examples, the BS 1402 transmits this DRX configuration information via RRC signaling.

At #1410, the UE 1404 initially is configured for the first SSSG. Thus, the UE 1404 may monitor for downlink (e.g., PDCCH) transmissions by the BS 1402.

At #1412, the BS 1402 schedules a transmission to the UE 1404. Accordingly, the BS 1402 transmits a scheduling DCI to the UE 1404 at #1414 and transmits the scheduled transmission at #1416. As discussed herein, this transmission may be a data burst of a periodic transmission.

At #1418, at some point in time, the BS 1402 configures the UE 1404 to switch to SSSG#1 based on a DRX ON time. For example, the BS 1402 may send an indication that the UE 1404 is to switch to SSSG#1 in conjunction with a switch by the UE 1404 to an On_Duration of the DRX cycle configured for the UE 1404 at #1408. In some examples, the BS 1402 may transmit this indication in a timer duration hit field of a DCI.

At #1420, at the end of the transmission of #1416, the BS 1402 transmits an SSSG switch request to the UE 1404. In some examples, the BS 1402 transmits this SSSG switch request via a DCI. In some examples, this DCI may include the indication of #1418.

At #1422 (e.g., in response to the SSSG switch request), the UE 1404 switches to SSSG#2. Here, the UE 1404 may enter a low power mode to conserve battery power.

At #1424, the UE 1404 switches back to SSSG#1 at the beginning of the next ON time (e.g., On_Duration) of the DRX cycle configured for the UE 1404 (e.g., at #1408). Thus, the UE 1404 may again monitor one or more downlink channels in conjunction with receiving the next transmission (e.g., the next data burst) from the BS 1402.

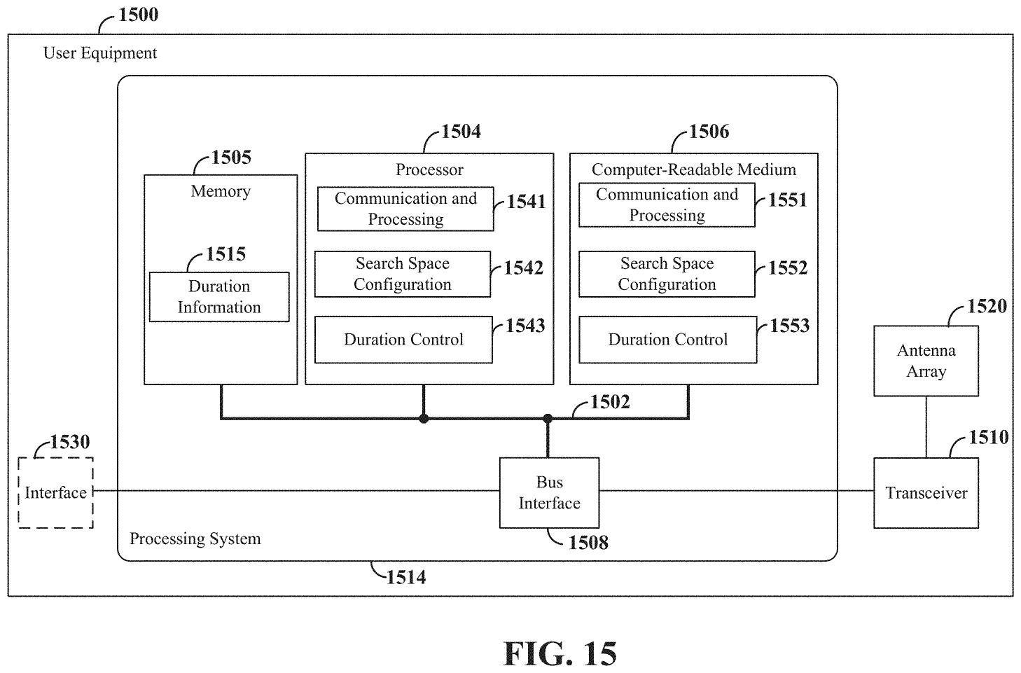

FIG. 15 is a block diagram illustrating an example of a hardware implementation for a UE 1500 employing a processing system 1514. For example, the UE 1500 may be a device configured to wirelessly communicate with a base station, as discussed in any one or more of FIGS. 1-14. In some implementations, the UE 1500 may correspond to any of the UEs or scheduled entities shown in any of FIGS. 1, 2, 9, 13, and 14.

In accordance with various aspects of the disclosure, an element, or any portion of an element, or any combination of elements may be implemented with the processing system 1514. The processing system 1514 may include one or more processors 1504. Examples of processors 1504 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the UE 1500 may be configured to perform any one or more of the functions described herein. That is, the processor 1504, as utilized in a UE 1500, may be used to implement any one or more of the processes and procedures described herein.

The processor 1504 may in some instances be implemented via a baseband or modem chip and in other implementations, the processor 1504 may include a number of devices distinct and different from a baseband or modem chip (e.g., in such scenarios as may work in concert to achieve examples discussed herein). And as mentioned above, various hardware arrangements and components outside of a baseband modem processor can be used in implementations, including RF-chains, power amplifiers, modulators, buffers, interleavers, adders/summers, etc.

In this example, the processing system 1514 may be implemented with a bus architecture, represented generally by the bus 1502. The bus 1502 may include any number of interconnecting buses and bridges depending on the specific application of the processing system 1514 and the overall design constraints. The bus 1502 communicatively couples together various circuits including one or more processors (represented generally by the processor 1504), a memory 1505, and computer-readable media (represented generally by the computer-readable medium 1506). The bus 1502 may also link various other circuits such as timing sources, peripherals, voltage regulators, and power management circuits, which are well known in the art, and therefore, will not be described any further. A bus interface 1508 provides an interface between the bus 1502 and a transceiver 1510 and between the bus 1502 and an interface 1530. The transceiver 1510 provides a communication interface or means for communicating with various other apparatus over a wireless transmission medium. In some examples, the UE may include two or more transceivers 1510. The interface 1530 provides a communication interface or means of communicating with various other apparatuses and devices (e.g., other devices housed within the same apparatus as the UE or other external apparatuses) over an internal bus or external transmission medium, such as an Ethernet cable. Depending upon the nature of the apparatus, the interface 1530 may include a user interface (e.g., keypad, display, speaker, microphone, joystick). Of course, such a user interface is optional, and may be omitted in some examples, such as an IoT device.

The processor 1504 is responsible for managing the bus 1502 and general processing, including the execution of software stored on the computer-readable medium 1506. The software, when executed by the processor 1504, causes the processing system 1514 to perform the various functions described below for any particular apparatus. The computer-readable medium 1506 and the memory 1505 may also be used for storing data that is manipulated by the processor 1504 when executing software. For example, the memory 1505 may store duration information 1515 (e.g., SSSG timer absolute values, SSSG timer relative values, or codepoint values) used by the processor 1504 in cooperation with the transceiver 1510 for communicating with a base station.

One or more processors 1504 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 1506.

The computer-readable medium 1506 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1506 may reside in the processing system 1514, external to the processing system 1514, or distributed across multiple entities including the processing system 1514. The computer-readable medium 1506 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

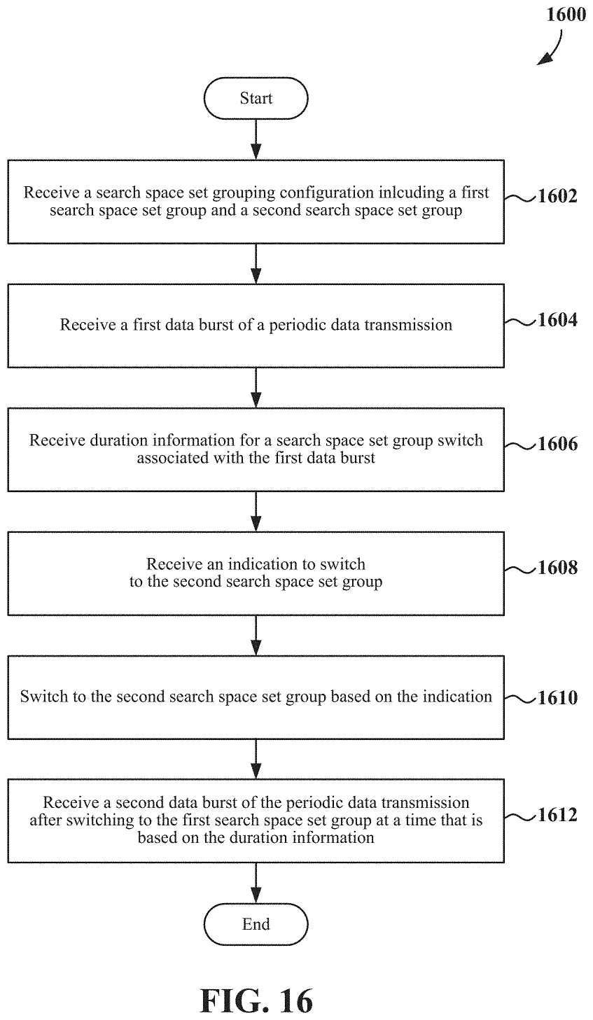

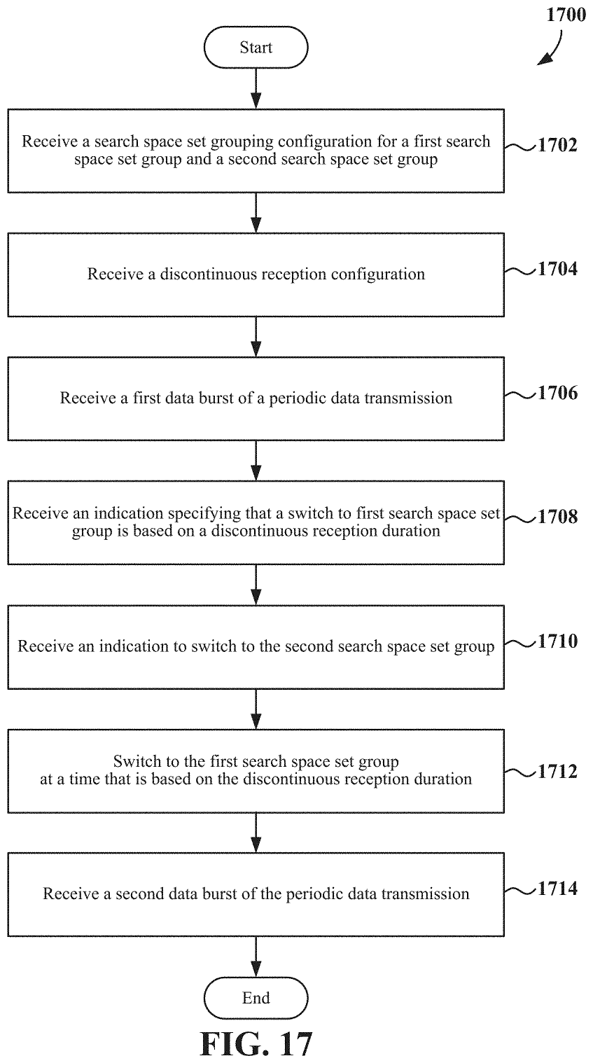

The UE 1500 may be configured to perform any one or more of the operations described herein (e.g., as described above in conjunction with FIGS. 1-14 and as described below in conjunction with FIGS. 16-17). In some aspects of the disclosure, the processor 1504, as utilized in the UE 1500, may include circuitry configured for various functions.

The processor 1504 may include communication and processing circuitry 1541. The communication and processing circuitry 1541 may be configured to communicate with a base station, such as a gNB. The communication and processing circuitry 1541 may include one or more hardware components that provide the physical structure that performs various processes related to wireless communication (e.g., signal reception and/or signal transmission) as described herein. The communication and processing circuitry 1541 may further include one or more hardware components that provide the physical structure that performs various processes related to signal processing (e.g., processing a received signal and/or processing a signal for transmission) as described herein. In some examples, the communication and processing circuitry 1541 may include two or more transmit/receive chains, each configured to process signals in a different RAT (or RAN) type. The communication and processing circuitry 1541 may further be configured to execute communication and processing software 1551 included on the computer-readable medium 1506 to implement one or more functions described herein.

In some implementations where the communication involves receiving information, the communication and processing circuitry 1541 may obtain information from a component of the UE 1500 (e.g., from the transceiver 1510 that receives the information via radio frequency signaling or some other type of signaling suitable for the applicable communication medium), process (e.g., decode) the information, and output the processed information. For example, the communication and processing circuitry 1541 may output the information to another component of the processor 1504, to the memory 1505, or to the bus interface 1508. In some examples, the communication and processing circuitry 1541 may receive one or more of signals, messages, other information, or any combination thereof. In some examples, the communication and processing circuitry 1541 may receive information via one or more channels. In some examples, the communication and processing circuitry 1541 may include functionality for a means for receiving. In some examples, the communication and processing circuitry 1541 may include functionality for a means for decoding.

In some implementations where the communication involves sending (e.g., transmitting) information, the communication and processing circuitry 1541 may obtain information (e.g., from another component of the processor 1504, the memory 1505, or the bus interface 1508), process (e.g., encode) the information, and output the processed information. For example, the communication and processing circuitry 1541 may output the information to the transceiver 1510 (e.g., that transmits the information via radio frequency signaling or some other type of signaling suitable for the applicable communication medium). In some examples, the communication and processing circuitry 1541 may send one or more of signals, messages, other information, or any combination thereof. In some examples, the communication and processing circuitry 1541 may send information via one or more channels. In some examples, the communication and processing circuitry 1541 may include functionality for a means for sending (e.g., a means for transmitting). In some examples, the communication and processing circuitry 1541 may include functionality for a means for encoding.

The communication and processing circuitry 1541 may include functionality for a means for receiving a data burst of a periodic data transmission. For example, the communication and processing circuitry 1541 may be configured to periodically (e.g., semi-periodically) receive a first data burst, a second data burst, and so on, from a gNB via a PDSCH. In some examples, the communication and processing circuitry 1541 may be configured to receive a data burst after the UE 1500 switches from one SSSG mode of operation to another SSSG mode of operation in response to the expiration of an SSSG timer or in response to the commencement of a DRX On-Duration.

The processor 1504 may include search space configuration circuitry 1542 configured to perform search space configuration-related operations as discussed herein (e.g., one or more of the operations described in conjunction with FIGS. 9-14). The search space configuration circuitry 1542 may be configured to execute search space configuration software 1552 included on the computer-readable medium 1506 to implement one or more functions described herein.

The search space configuration circuitry 1542 may include functionality for a means for receiving a search space set grouping configuration (e.g., as discussed above in conjunction with FIGS. 13 and 14). For example, the search space configuration circuitry 1542 may be configured to process an RRC message received on a PDSCH to extract SSSG configuration information (e.g., specifying SSSG#1 and SSSG#2) included in the RRC message.

The processor 1504 may include duration control circuitry 1543 configured to perform duration control-related operations as discussed herein (e.g., one or more of the operations described in conjunction with FIGS. 9-14). The duration control circuitry 1543 may be configured to execute duration control software 1553 included on the computer-readable medium 1506 to implement one or more functions described herein.

The duration control circuitry 1543 may include functionality for a means for receiving duration information (e.g., as discussed above in conjunction with FIGS. 13 and 14). For example, the duration control circuitry 1543 may be configured to process a DCI received on a PDCCH from a gNB or a MAC-CE received on a PDSCH from a gNB to extract duration information (e.g., specifying an absolute timer value, a relative timer value, an index value, or a codepoint value) included in the DCI or MAC-CE.

The duration control circuitry 1543 may include functionality for a means for receiving a discontinuous reception configuration (e.g., as discussed above in conjunction with FIG. 14). For example, the duration control circuitry 1543 may be configured to process an RRC message received on a PDSCH from a gNB to extract DRX configuration information (e.g., DRX cycle information) included in the RRC message.

The duration control circuitry 1543 may include functionality for a means for receiving an indication specifying that a switch to a search space set group is based on a discontinuous reception duration (e.g., as discussed above in conjunction with FIG. 14). For example, the duration control circuitry 1543 may be configured to process a DCI received on a PDCCH from a gNB or a MAC-CE received on a PDSCH from a gNB to extract an indication (e.g., a codepoint value) included in the DCI or MAC-CE.

The duration control circuitry 1543 may include functionality for a means for receiving an indication to switch to a search space set group (e.g., as discussed above in conjunction with FIGS. 13 and 14). For example, the duration control circuitry 1543 may be configured to process a DCI received on a PDCCH from a gNB to extract an indication (e.g., a Switch Request) included in the DCI.

The duration control circuitry 1543 may include functionality for a means for switching to a search space set group (e.g., as discussed above in conjunction with FIGS. 13 and 14). For example, the duration control circuitry 1543 may be configured to switch from a first SSSG (e.g., SSSG#1) mode of operation (e.g., that includes monitoring PDCCH) to a second SSSG (e.g., SSSG#2) mode of operation that does not include monitoring PDCCH) in response to the receipt of a Switch Request. As another example, the duration control circuitry 1543 may be configured to switch from the second SSSG mode of operation to the first SSSG mode of operation in response to the expiration of an SSSG timer or in response to the commencement of a DRX On-Duration.

FIG. 16 is a flow chart illustrating an example method 1600 for wireless communication according to some aspects of the disclosure. As described herein, some or all illustrated features may be omitted in a particular implementation within the scope of the present disclosure, and some illustrated features may not be required for implementation of all examples. In some examples, the method 1600 may be carried out by the UE 1500 illustrated in FIG. 15. In some examples, the method 1600 may be carried out by any suitable apparatus or means for carrying out the functions or algorithm described below.

At block 1602, the user equipment may receive a search space set grouping configuration including a first search space set group and a second search space set group. For example, the search space configuration circuitry 1542 together with the communication and processing circuitry 1541 and the transceiver 1510, shown and described above in connection with FIG. 15, may provide a means to receive a search space set grouping configuration including a first search space set group and a second search space set group.

At block 1604, a user equipment may receive a first data burst of a periodic data transmission. For example, the communication and processing circuitry 1541 and the transceiver 1510, shown and described above in connection with FIG. 15, may provide a means to receive a first data burst of a periodic data transmission.

At block 1606, the user equipment may receive duration information for a search space set group switch associated with the first data burst. For example, the duration control circuitry 1543 together with the communication and processing circuitry 1541 and the transceiver 1510, shown and described above in connection with FIG. 15, may provide a means to receive duration information for a search space set group switch associated with the first data burst.

At block 1608, the user equipment may receive an indication to switch to the second search space set group. For example, the duration control circuitry 1543 together with the communication and processing circuitry 1541 and the transceiver 1510, shown and described above in connection with FIG. 15, may provide a means to receive an indication to switch to the second search space set group.

At block 1610, the user equipment may switch to the second search space set group based on the indication. For example, the duration control circuitry 1543, shown and described above in connection with FIG. 15, may provide a means to switch to the second search space set group based on the indication.

At block 1612, a user equipment may receive a second data burst of the periodic data transmission after switching to the first search space set group at a time that is based on the duration information. For example, the communication and processing circuitry 1541 and the transceiver 1510, shown and described above in connection with FIG. 15, may provide a means to receive a second data burst of the periodic data transmission after switching to the first search space set group at a tine that is based on the duration information.

In some examples, the duration information may be indicative of a timer value for a timer. In some examples, the user equipment may commence the timer based on the switch to the second search space set group and switch to the first search space set group after expiration of the timer. In some examples, the user equipment may receive the indication to switch to the second search space set group via downlink control information (DCI).

In some examples, the duration information may include an absolute timer value for a timer for the switching to the first search space set group. In some examples, the user equipment may receive a list of absolute timer values for a timer for the switching to the first search space set group. In some examples, the duration information may include an indication of a particular absolute timer value from the list of absolute timer values.

In some examples, the duration information may include a relative timer value for a timer for the switching to the first search space set group. In some examples, the user equipment may receive a list of relative timer values for a timer for the switching to the first search space set group. In some examples, the duration information may include an indication of a particular relative timer value from the list of relative timer values.

In some examples, the duration information may be based on at least one of quality of service associated with the periodic data transmission, a downlink data arrival time associated with the periodic data transmission, jitter associated with the periodic data transmission, a traffic characteristic associated with the periodic data transmission, a periodicity associated with the periodic data transmission, a configuration of a cell used to transmit the periodic data transmission, a quantity of user equipment served by the cell used to transmit the periodic data transmission, a processing constraint of a base station, information regarding an arrival time at the user equipment for an uplink data transmission, or a combination thereof.

In some examples, the duration information may include an indication to switch to the first search space set group based on a discontinuous reception duration. In some examples, the indication to switch to the first search space set group may specify that the user equipment is to switch to the first search space set group based on a beginning of a discontinuous reception ON duration that occurs after the switch to the second search space set group. In some examples, the duration information may include an indication to switch to the first search space set group at a time based on a beginning of a discontinuous reception ON duration that occurs after the switch to the second search space set group. In some examples, the user equipment may receive the indication to switch to the first search space set group via downlink control information (DCI). In some examples, the indication to switch to the first search space set group may include a codepoint value.

In some examples, the user equipment may receive the duration information via downlink control information (DCI). In some examples, the user equipment may receive the duration information via a medium access control-control element (MAC-CE).

FIG. 17 is a flow chart illustrating an example method 1700 for wireless communication according to some aspects of the disclosure. As described herein, some or all illustrated features may be omitted in a particular implementation within the scope of the present disclosure, and some illustrated features may not be required for implementation of all examples. In some examples, the method 1700 may be carried out by the UE 1500 illustrated in FIG. 15. In some examples, the method 1700 may be carried out by any suitable apparatus or means for carrying out the functions or algorithm described below.

At block 1702, the user equipment may receive a search space set grouping configuration for a first search space set group and a second search space set group. For example, the search space configuration circuitry 1542 together with the communication and processing circuitry 1541 and the transceiver 1510, shown and described above in connection with FIG. 15, may provide a means to receive a search space set grouping configuration for a first search space set group and a second search space set group.

At block 1704, a user equipment may receive a discontinuous reception configuration. For example, the duration control circuitry 1543 together with the communication and processing circuitry 1541 and the transceiver 1510, shown and described above in connection with FIG. 15, may provide a means to receive a discontinuous reception configuration.

At block 1706, the user equipment may receive a first data burst of a periodic data transmission. For example, the communication and processing circuitry 1541 and the transceiver 1510, shown and described above in connection with FIG. 15, may provide a means to receive a first data burst of a periodic data transmission.

At block 1708, the user equipment may receive an indication specifying that a switch to first search space set group is based on a discontinuous reception duration. For example, the duration control circuitry 1543 together with the communication and processing circuitry 1541 and the transceiver 1510, shown and described above in connection with FIG. 15, may provide a means to receive an indication specifying that a switch to first search space set group is based on a discontinuous reception duration.

At block 1710, the user equipment may receive an indication to switch to the second search space set group. For example, the duration control circuitry 1543 together with the communication and processing circuitry 1541 and the transceiver 1510, shown and described above in connection with FIG. 15, may provide a means to receive an indication to switch to the second search space set group.

At block 1712, the user equipment may switch to the first search space set group at a time that is based on the discontinuous reception duration. For example, the duration control circuitry 1543, shown and described above in connection with FIG. 15, may provide a means to switch to the first search space set group at a time that is based on the discontinuous reception duration.

At block 1714, a user equipment may receive a second data burst of the periodic data transmission. For example, the communication and processing circuitry 1541 and the transceiver 1510, shown and described above in connection with FIG. 15, may provide a means to receive a second data burst of the periodic data transmission.

In one configuration, the UE 1500 includes means for receiving a search space set grouping configuration including a first search space set group and a second search space set group, means for receiving a first data burst of a periodic data transmission, means for receiving duration information for a search space set group switch associated with the first data burst, means for receiving an indication to switch to the second search space set group, means for switching to the second search space set group based on the indication, and means for receiving a second data burst of the periodic data transmission after switching to the first search space set group at a time that is based on the duration information. In one aspect, the aforementioned means may be the processor 1504 shown in FIG. 15 configured to perform the functions recited by the aforementioned means (e.g., as discussed above). In another aspect, the aforementioned means may be a circuit or any apparatus configured to perform the functions recited by the aforementioned means.

Of course, in the above examples, the circuitry included in the processor 1504 is merely provided as an example, and other means for carrying out the described functions may be included within various aspects of the present disclosure, including but not limited to the instructions stored in the computer-readable medium 1506, or any other suitable apparatus or means described in any one or more of FIGS. 1, 2, 9, 13, 14, and 15, and utilizing, for example, the methods and/or algorithms described herein in relation to FIGS. 16-17.

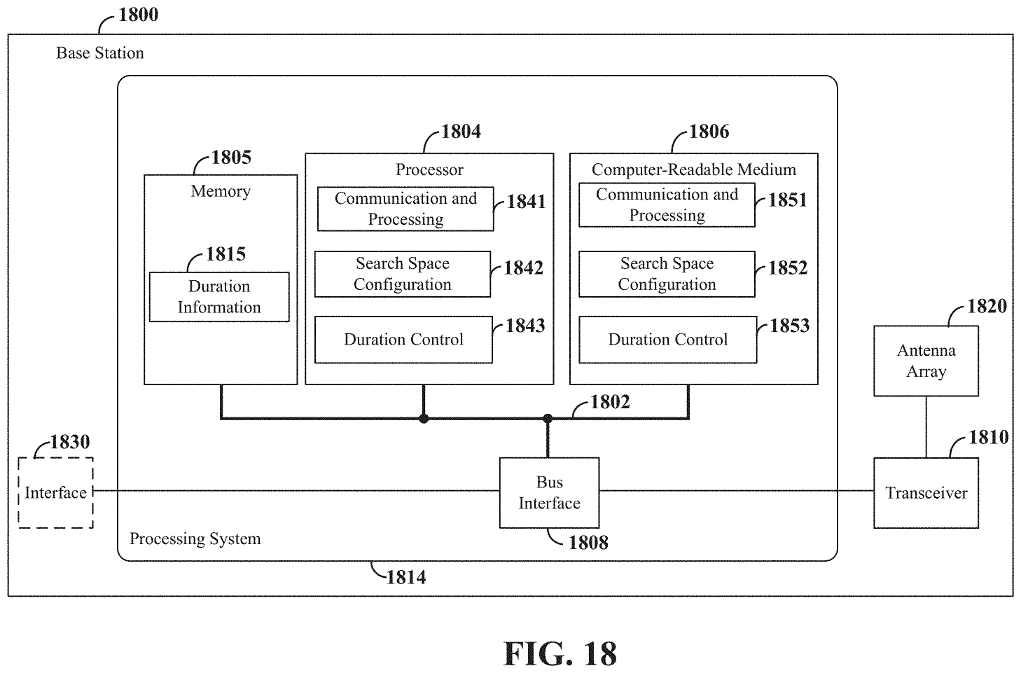

FIG. 18 is a conceptual diagram illustrating an example of a hardware implementation for a base station 1800 employing a processing system 1814. In some implementations, the base station 1800 may correspond to any of the base stations (e.g., gNBs) or scheduling entities as illustrated in any of FIGS. 1, 2, 9, 13, and 14.

In accordance with various aspects of the disclosure, an element, or any portion of an element, or any combination of elements may be implemented with the processing system 1814. The processing system may include one or more processors 1804. The processing system 1814 may be substantially the same as the processing system 1514 illustrated in FIG. 15, including a bus interface 1808, a bus 1802, memory 1805, a processor 1804, a transceiver 1810, an antenna array 1820, and a computer-readable medium 1806. The memory 1805 may store duration information 1815 (e.g., SSSG timer absolute values, SSSG tinier relative values, or codepoint values) used by the processor 1804 in cooperation with the transceiver 1810 for communicating with a UE. Furthermore, the base station 1800 may include an interface 1830 (e.g., a network interface) that provides a means for communicating with at least one other apparatus within a core network and with at least one radio access network.

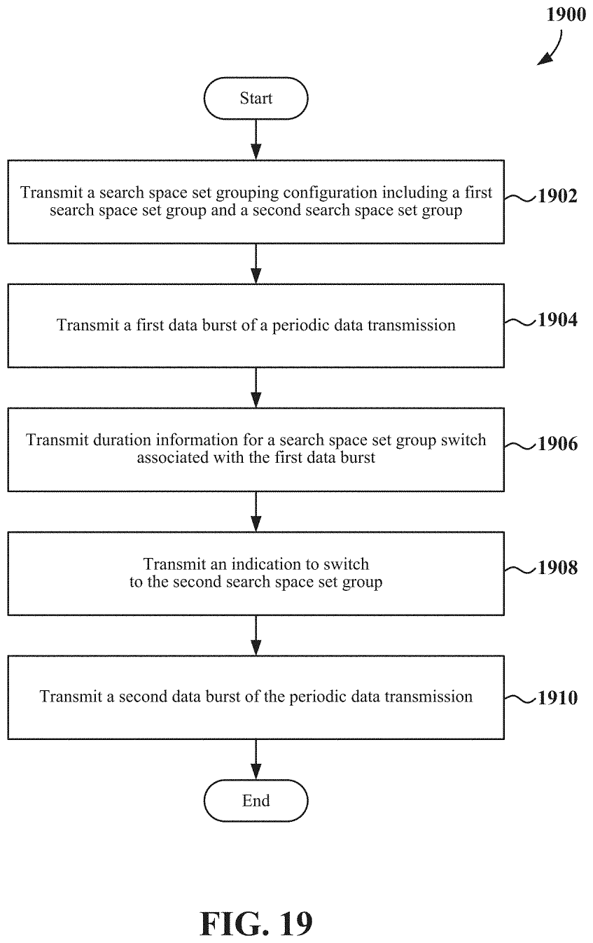

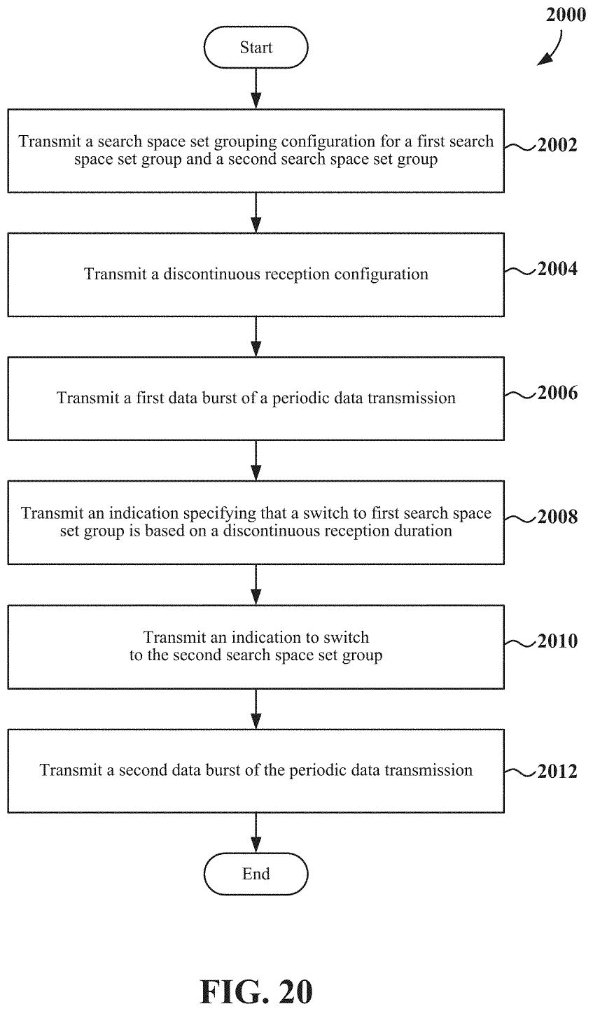

The base station 1800 may be configured to perform any one or more of the operations described herein (e.g., as described above in conjunction with FIGS. 1-14 and as described below in conjunction with FIGS. 19-20). In some aspects of the disclosure, the processor 1804, as utilized in the base station 1800, may include circuitry configured for various functions.

The processor 1804 may be configured to generate, schedule, and modify a resource assignment or grant of time-frequency resources (e.g., a set of one or more resource elements). For example, the processor 1804 may schedule time-frequency resources within a plurality of time division duplex (TDD) and/or frequency division duplex (FDD) subframes, slots, and/or mini-slots to carry user data traffic and/or control information to and/or from multiple UEs.

The processor 1804 may be configured to schedule resources for the transmission of sidelink signals, downlink signals, or uplink signals. The processor 1804 may be configured to schedule resources for measurement operations.

In some aspects of the disclosure, the processor 1804 may include communication and processing circuitry 1841. The communication and processing circuitry 1844 may be configured to communicate with a UE. The communication and processing circuitry 1841 may include one or more hardware components that provide the physical structure that performs various processes related to communication (e.g., signal reception and/or signal transmission) as described herein. The communication and processing circuitry 1841 may further include one or more hardware components that provide the physical structure that performs various processes related to signal processing (e.g., processing a received signal and/or processing a signal for transmission) as described herein. The communication and processing circuitry 1841 may further be configured to execute communication and processing software 1851 included on the computer-readable medium 1806 to implement one or more functions described herein.

The communication and processing circuitry 1841 may further be configured to receive an indication from the UE. For example, the indication may be included in a MAC-CE carried in a PUSCH, or included in an RRC message, or included in a dedicated PUCCH or PUSCH. The communication and processing circuitry 1841 may further be configured to receive a scheduling request from a UE for an uplink grant.

In some implementations wherein the communication involves receiving information, the communication and processing circuitry 1841 may obtain information from a component of the base station 1800 (e.g., from the transceiver 1810 that receives the information via radio frequency signaling or some other type of signaling suitable for the applicable communication medium), process (e.g., decode) the information, and output the processed information. For example, the communication and processing circuitry 1841 may output the information to another component of the processor 1804, to the memory 1805, or to the bus interface 1808. In some examples, the communication and processing circuitry 1841 may receive one or more of signals, messages, other information, or any combination thereof. In some examples, the communication and processing circuitry 1841 may receive information via one or more channels. In some examples, the communication and processing circuitry 1841 may include functionality for a means for receiving. In some examples, the communication and processing circuitry 1841 may include functionality for a means for decoding.

In some implementations wherein the communication involves sending (e.g., transmitting) information, the communication and processing circuitry 1841 may obtain information (e.g., from another component of the processor 1804, the memory 1805, or the bus interface 1808), process (e.g., encode) the information, and output the processed information. For example, the communication and processing circuitry 1841 may output the information to the transceiver 1810 (e.g., that transmits the information via radio frequency signaling or some other type of signaling suitable for the applicable communication medium). In some examples, the communication and processing circuitry 1841 may send one or more of signals, messages, other information, or any combination thereof. In some examples, the communication and processing circuitry 1841 may send information via one or more channels. In some examples, the communication and processing circuitry 1841 may include functionality for a means for sending (e.g., a means for transmitting). In some examples, the communication and processing circuitry 1841 may include functionality for a means for encoding.

The communication and processing circuitry 1841 may include functionality for a means for transmitting a data burst of a periodic data transmission. For example, the communication and processing circuitry 1841 may be configured to periodically (e.g., semi-periodically) transmit a first data burst, a second data burst, and so on, to a UE via a PDSCH.

The processor 1804 may include search space configuration circuitry 1842 configured to perform search space configuration-related operations as discussed herein (e.g., one or more of the operations described in conjunction with FIGS. 9-14). The search space configuration circuitry 1842 may be configured to execute search space configuration software 1852 included on the computer-readable medium 1806 to implement one or more functions described herein.

The search space configuration circuitry 1842 may include functionality for a means for transmitting a search space set grouping configuration (e.g., as discussed above in conjunction with FIGS. 13 and 14). For example, the search space configuration circuitry 1842 may be configured to select an SSSG configuration (e.g., specifying SSSG#1 and SSSG#2) for a UE, generate an RRC message including the SSSG configuration information, and transmit the RRC message on a PDSCH.

The processor 1804 may include duration control circuitry 1843 configured to perform duration control-related operations as discussed herein (e.g., one or more of the operations described in conjunction with FIGS. 9-14). The duration control circuitry 1843 may be configured to execute duration control software 1853 included on the computer-readable medium 1806 to implement one or more functions described herein.

The duration control circuitry 1843 may include functionality for a means for transmitting duration information (e.g., as discussed above in conjunction with FIGS. 13 and 14). For example, the duration control circuitry 1843 may be configured to determine duration information (e.g., specifying an absolute timer value, relative timer value, an index value, or a codepoint value) for a UE, generate a DCI or a MAC-CE including the duration information, and transmit the DCI to the UE via a PDCCH or transmit the MAC-CE to the UE via a PDSCH.

The duration control circuitry 1843 may include functionality for a means for transmitting a discontinuous reception configuration (e.g., as discussed above in conjunction with FIG. 14). For example, the duration control circuitry 1843 may be configured to select a DRX configuration (e.g., specifying DRX cycle information) for a UE, generate an RRC message including the DRX configuration information, and transmit the RRC message on a PDSCH.

The duration control circuitry 1843 may include functionality for a means for transmitting an indication specifying that a switch to a search space set group is based on a discontinuous reception duration (e.g., as discussed above in conjunction with FIG. 14). For example, the duration control circuitry 1843 may be configured to determine that a UE can be advantageously configured to use a DRX cycle to switch between SSSGs to save battery power), generate a DCI or a MAC-CE including an indication of this determination, and transmit the DCI to the UE via a PDCCH or transmit the MAC-CE to the UE via a PDSCH.

The duration control circuitry 1843 may include functionality for a means for transmitting an indication to switch to a search space set group (e.g., as discussed above in conjunction with FIGS. 13 and 14). For example, the duration control circuitry 1843 may be configured to determine that a data burst has ended or will end (e.g., within a window of time), generate a DCI including an indication to switch SSSGs (e.g., a Switch Request), and transmit the DCI on a PDCCH.

FIG. 19 is a flow chart illustrating an example method 1900 for wireless communication according to some aspects of the disclosure. As described herein, some or all illustrated features may be omitted in a particular implementation within the scope of the present disclosure, and some illustrated features may not be required for implementation of all examples. In some examples, the method 1900 may be carried out by the BS 1800 illustrated in FIG. 18. In some examples, the method 1900 may be carried out by any suitable apparatus or means for carrying out the functions or algorithm described below.

At block 1902, the base station may transmit a search space set grouping configuration including a first search space set group and a second search space set group. For example, the search space configuration circuitry 1842 together with the communication and processing circuitry 1841 and the transceiver 1810, shown and described above in connection with FIG. 18, may provide a means to transmit a search space set grouping configuration including a first search space set group and a second search space set group.

At block 1904, a base station may transmit a first data burst of a periodic data transmission. For example, the communication and processing circuitry 1841 and the transceiver 1810, shown and described above in connection with FIG. 18, may provide a means to transmit a first data burst of a periodic data transmission.

At block 1906, the base station may transmit duration information for a search space set group switch associated with the first data burst. For example, the duration control circuitry 1843 together with the communication and processing circuitry 1841 and the transceiver 1810, shown and described above in connection with FIG. 18, may provide a means to transmit duration information for a search space set group switch associated with the first data burst.

At block 1908, the base station may transmit an indication to switch to the second search space set group. For example, the duration control circuitry 1843 together with the communication and processing circuitry 1841 and the transceiver 1810, shown and described above in connection with FIG. 18, may provide a means to transmit an indication to switch to the second search space set group.

At block 1910, a base station may transmit a second data burst of the periodic data transmission. For example, the communication and processing circuitry 1841 and the transceiver 1810, shown and described above in connection with FIG. 18, may provide a means to transmit a second data burst of the periodic data transmission.

In some examples, the duration information may be indicative of a timer value for a timer for switching a user equipment to the first search space set group. In some examples, the base station may transmit the indication to switch to the second search space set group via downlink control information (DCI).

In some examples, the duration information may include an absolute timer value for a timer for the switching to the first search space set group. In some examples, the base station may transmit a list of absolute timer values for a timer for the switching to the first search space set group. In some examples, the duration information may include an indication of a particular absolute timer value from the list of absolute timer values.

In some examples, the duration information may include a relative timer value for a timer for the switching to the first search space set group. In some examples, the base station may transmit a list of relative timer values for a timer for the switching to the first search space set group. In some examples, the duration information may include an indication of a particular relative timer value from the list of relative timer values.

In some examples, the base station may determine the duration information based on at least one of a quality of service associated with the periodic data transmission, a downlink data arrival time associated with the periodic data transmission, jitter associated with the periodic data transmission, a traffic characteristic associated with the periodic data transmission, a periodicity associated with the periodic data transmission, a configuration of a cell used to transmit the periodic data transmission, a quantity of user equipment served by the cell used to transmit the periodic data transmission, a processing constraint of the base station, information regarding an arrival time at the base station for an uplink data transmission, or a combination thereof.

In some examples, the base station may determine first duration information, determine second duration information associated with the first data burst, and determine that the second duration information is different from the first duration information. In some examples, the base station may transmit the duration information based on the determination that the second duration information is different from the first duration information. In some examples, the base station may invoke the transmission the duration information based on the determination that the second duration information is different from the first duration information.

In some examples, the duration information may include an indication to switch to the first search space set group based on a discontinuous reception duration. In some examples, the indication to switch to the first search space set group may specify that a user equipment is to switch to the first search space set group based on a beginning of a discontinuous reception ON duration that occurs after the switch to the second search space set group. In some examples, the duration information may include an indication to switch to the first search space set group at a time based on a beginning of a discontinuous reception ON duration that occurs after the switch to the second search space set group. In some examples, the base station may transmit the indication to switch to the first search space set group via downlink control information (DCI). In some examples, the indication to switch to the first search space set group may include a codepoint value.

In some examples, the base station may transmit the duration information via downlink control information (DCI). In some examples, the base station may transmit the duration information via a medium access control-control element (MAC-CE).

FIG. 20 is a flow chart illustrating an example method 2000 for wireless communication according to some aspects of the disclosure. As described herein, some or all illustrated features may be omitted in a particular implementation within the scope of the present disclosure, and some illustrated features may not be required for implementation of all examples. In some examples, the method 2000 may be carried out by the BS 1800 illustrated in FIG. 18. In some examples, the method 2000 may be carried out by any suitable apparatus or means for carrying out the functions or algorithm described below.

At block 2002, the base station may transmit a search space set grouping configuration for a first search space set group and a second search space set group. For example, the search space configuration circuitry 1842 together with the communication and processing circuitry 1841 and the transceiver 1810, shown and described above in connection with FIG. 18, may provide a means to transmit a search space set grouping configuration for a first search space set group and a second search space set group.

At block 2004, the base station may transmit a discontinuous reception configuration. For example, the duration control circuitry 1843 together with the communication and processing circuitry 1841 and the transceiver 1810, shown and described above in connection with FIG. 18, may provide a means to transmit a discontinuous reception configuration.

At block 2006, a base station may transmit a first data burst of a periodic data transmission. For example, the communication and processing circuitry 1841 and the transceiver 1810, shown and described above in connection with FIG. 18, may provide a means to transmit a first data burst of a periodic data transmission.

At block 2008, the base station may transmit an indication specifying that a switch to first search space set group is based on a discontinuous reception duration. For example, the duration control circuitry 1843 together with the communication and processing circuitry 1841 and the transceiver 1810, shown and described above in connection with FIG. 18, may provide a means to transmit an indication specifying that a switch to first search space set group is based on a discontinuous reception duration.

At block 2010, the base station may transmit an indication to switch to the second search space set group. For example, the duration control circuitry 1843 together with the communication and processing circuitry 1841 and the transceiver 1810, shown and described above in connection with FIG. 18, may provide a means to transmit an indication to switch to the second search space set group.

At block 2012, a base station may transmit a second data burst of the periodic data transmission. For example, the communication and processing circuitry 1841 and the transceiver 1810, shown and described above in connection with FIG. 18, may provide a means to transmit a second data burst of the periodic data transmission.

In one configuration, the BS 1800 includes means for transmitting a search space set grouping configuration including a first search space set group and a second search space set group, means for transmitting a first data burst of a periodic data transmission, means for transmitting duration information for a search space set group switch associated with the first data burst, means for transmitting an indication to switch to the second search space set group, and means for transmitting a second data burst of the periodic data transmission. In one aspect, the aforementioned means may be the processor 1804 shown in FIG. 18 configured to perform the functions recited by the aforementioned means (e.g., as discussed above). In another aspect, the aforementioned means may be a circuit or any apparatus configured to perform the functions recited by the aforementioned means.

Of course, in the above examples, the circuitry included in the processor 1804 is merely provided as an example, and other means for carrying out the described functions may be included within various aspects of the present disclosure, including but not limited to the instructions stored in the computer-readable medium 1806, or any other suitable apparatus or means described in any one or more of FIGS. 1, 2, 9, 13, 14, and 18, and utilizing, for example, the methods and/or algorithms described herein in relation to FIGS. 19-20.

The methods shown in FIGS. 16-17 and 19-20 may include additional aspects, such as any single aspect or any combination of aspects described below and/or in connection with one or more other processes described elsewhere herein. The following provides an overview of several aspects of the present disclosure.

Aspect 1: A method for wireless communication at a user equipment, the method comprising receiving a search space set grouping configuration including a first search space set group and a second search space set group, receiving a first data burst of a periodic data transmission, receiving duration information for a search space set group switch associated with the first data burst, receiving an indication to switch to the second search space set group, switching to the second search space set group based on the indication, and receiving a second data burst of the periodic data transmission after switching to the first search space set group at a time that is based on the duration information.

Aspect 2: The method of aspect 1, wherein: the duration information is indicative of a timer value for a timer; the method further comprises commencing the tinier based on the switch to the second search space set group; and the method further comprises switching to the first search space set group after expiration of the tuner.

Aspect 3: The method of aspect 1 or 2, wherein the method further comprises receiving the indication to switch to the second search space set group via downlink control information (DCI).

Aspect 4: The method of any of aspects 1 through 3, wherein the duration information comprises an absolute timer value for a timer for the switching to the first search space set group.

Aspect 5: The method of any of aspects 1 through 3, wherein: the method further comprises receiving a list of absolute timer values for a timer for the switching to the first search space set group; and the duration information comprises an indication of a particular absolute tuner value from the list of absolute timer values.

Aspect 6: The method of any of aspects 1 through 3, wherein the duration information comprises a relative timer value for a tinier for the switching to the first search space set group.

Aspect 7: The method of any of aspects 1 through 3, wherein: the method further comprises receiving a list of relative timer values for a timer for the switching to the first search space set group; and the duration information comprises an indication of a particular relative timer value from the list of relative timer values.

Aspect 8: The method of any of aspects 1 through 7, wherein the duration information is based on at least one of: a quality of service associated with the periodic data transmission, a downlink data arrival time associated with the periodic data transmission, jitter associated with the periodic data transmission, a traffic characteristic associated with the periodic data transmission, a periodicity associated with the periodic data transmission, a configuration of a cell used to transmit the periodic data transmission, a quantity of user equipment served by the cell used to transmit the periodic data transmission, a processing constraint of a base station, information regarding an arrival time at the user equipment for an uplink data transmission, or a combination thereof.

Aspect 9: The method of aspect 1, wherein the duration information comprises an indication to switch to the first search space set group based on a discontinuous reception duration.

Aspect 10: The method of aspect 9, wherein the indication to switch to the first search space set group specifies that the user equipment is to switch to the first search space set group based on a beginning of a discontinuous reception ON duration that occurs after the switch to the second search space set group.

Aspect 11: The method of any of aspects 9 through 10, further comprising receiving the indication to switch to the first search space set group via downlink control information (DCI).

Aspect 12: The method of aspect 11, wherein the indication to switch to the first search space set group comprises a codepoint value.

Aspect 13: The method of any of aspects 1 through 12, further comprising receiving the duration information via downlink control information (DCI).

Aspect 14: The method of any of aspects 1, 2, 4 through 10 and 12, further comprising receiving the duration information via a medium access control-control element (MAC-CE).

Aspect 16: A method for wireless communication at a base station, the method comprising: transmitting a search space set grouping configuration including a first search space set group and a second search space set group, transmitting a first data burst of a periodic data transmission, transmitting duration information for a search space set group switch associated with the first data burst, transmitting an indication to switch to the second search space set group, and transmitting a second data burst of the periodic data transmission.

Aspect 17: The method of aspect 16, wherein the duration information is indicative of a tinier value for a timer for switching a user equipment to the first search space set group.

Aspect 18: The method of any of aspects 16 through 17, further comprising transmitting the indication to switch to the second search space set group via downlink control information (DCI).

Aspect 19: The method of any of aspects 16 through 18, wherein the duration information comprises an absolute timer value for a timer for the switching to the first search space set group.

Aspect 20: The method of any of aspects 16 through 18, wherein: the method further comprises transmitting a list of absolute tinier values for a timer for the switching to the first search space set group; and the duration information comprises an indication of a particular absolute timer value from the list of absolute timer values.

Aspect 21: The method of any of aspects 16 through 18, wherein the duration information comprises a relative timer value for a timer for the switching to the first search space set group.

Aspect 22: The method of any of aspects 16 through 18, wherein: the method further comprises transmitting a list of relative tinier values for a timer for the switching to the first search space set group; and the duration information comprises an indication of a particular relative timer value from the list of relative timer values.

Aspect 23: The method of any of aspects 16 through 22, further comprising determining the duration information based on at least one of: a quality of service associated with the periodic data transmission, a downlink data arrival time associated with the periodic data transmission, jitter associated with the periodic data transmission, a traffic characteristic associated with the periodic data transmission, a periodicity associated with the periodic data transmission, a configuration of a cell used to transmit the periodic data transmission, a quantity of user equipment served by the cell used to transmit the periodic data transmission, a processing constraint of the base station, information received from a user equipment regarding an arrival time of uplink data, or a combination thereof.

Aspect 24: The method of any of aspects 16 through 23, further comprising: determining first duration information; determining second duration information associated with the first data burst; determining that the second duration information is different from the first duration information; and invoking the transmission the duration information based on the determination that the second duration information is different from the first duration information.

Aspect 25: The method of any of aspects 16 through 24, wherein the duration information comprises an indication to switch to the first search space set group based on a discontinuous reception duration.

Aspect 26: The method of aspect 25, wherein the indication to switch to the first search space set group specifies that a user equipment is to switch to the first search space set group based on a beginning of a discontinuous reception ON duration that occurs after the switch to the second search space set group.

Aspect 27: The method of aspect 16, wherein: the method further comprises transmitting the indication to switch to the first search space set group via downlink control information (DCI) and the indication to switch to the first search space set group comprises a codepoint value.

Aspect 28: The method of any of aspects 16 through 27, further comprising transmitting the duration information via downlink control information (DCI).

Aspect 29: The method of any of aspects 16, 17, and 19 through 26, further comprising transmitting the duration information via a medium access control-control element (MAC-CE).

Aspect 30: A user equipment comprising: a transceiver configured to communicate with a radio access network, a memory, and a processor coupled to the transceiver and the memory, wherein the processor is configured to perform any one of aspects 1 through 15.

Aspect 31: An apparatus configured for wireless communication comprising at least one means for performing any one of aspects 1 through 15.

Aspect 32: A non-transitory computer-readable medium storing computer-executable code, comprising code for causing an apparatus to perform any one of aspects 1 through 15.

Aspect 33: A base station comprising: a transceiver, a memory, and a processor coupled to the transceiver and the memory, wherein the processor is configured to perform any one of aspects 16 through 29.

Aspect 34: An apparatus configured for wireless communication comprising at least one means for performing any one of aspects 16 through 29.

Aspect 35: A non-transitory computer-readable medium storing computer-executable code, comprising code for causing an apparatus to perform any one of aspects 16 through 29.

Several aspects of a wireless communication network have been presented with reference to an example implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing Institute of Electrical and Electronics Engineers (IEEE) 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure. As used herein, the term “determining” may encompass a wide variety of actions. For example, “determining” may include calculating, computing, processing, deriving, investigating, looking up (e.g., looking up in a table, a database or another data structure), ascertaining, resolving, selecting, choosing, establishing, receiving (e.g., receiving information), accessing (e.g., accessing data in a memory), and the like.

One or more of the components, steps, features and/or functions illustrated in FIGS. 1-20 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in any of FIGS. 1, 2, 9, 13, 14, 15, and 18 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of example processes. Based upon design preferences, it is understood that the specific order or hierarchy of steps in the methods may be rearranged. The accompanying method claims present elements of the various steps in a sample order and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b, and c. All structural and functional equivalents to the elements of the various aspects described throughout this disclosure that are known or later come to he known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A user equipment, comprising:
a transceiver;
a memory; and
a processor coupled to the memory and the transceiver, wherein the processor is configured to:
receive, via the transceiver, a search space set grouping configuration including a first search space set group and a second search space set group;
receive, via the transceiver, a first data burst of a periodic data transmission;
receive, via the transceiver, duration information for a search space set group switch associated with the first data burst;
receive, via the transceiver, an indication to switch to the second search space set group;
switch to the second search space set group based on the indication; and
receive, via the transceiver, a second data burst of the periodic data transmission after switching to the first search space set group at a time that is based on the duration information.

2. The user equipment of claim 1, wherein:
the duration information is indicative of a tuner value for a timer;
the processor is further configured to commence the timer based on the switch to the second search space set group; and
the processor is further configured to switch to the first search space set group after expiration of the timer.

3. The user equipment of claim 1, wherein the processor is further configured to receive the indication to switch to the second search space set group via downlink control information (DCI).

4. The user equipment of claim 1, wherein the duration information comprises an absolute timer value for a tinier for the switching to the first search space set group.

5. The user equipment of claim 1, wherein:
the processor is further configured to receive, via the transceiver, a list of absolute timer values for a timer for the switching to the first search space set group; and
the duration information comprises an indication of a particular absolute timer value from the list of absolute timer values.

6. The user equipment of claim 1, wherein the duration information comprises a relative timer value for a timer for the switching to the first search space set group.

7. The user equipment of claim 1, wherein:
the processor is further configured to receive, via the transceiver, a list of relative timer values for a timer for the switching to the first search space set group; and
the duration information comprises an indication of a particular relative timer value from the list of relative timer values.

8. The user equipment of claim 1, wherein the duration information is based on at least one of: a quality of service associated with the periodic data transmission, a downlink data arrival time associated with the periodic data transmission, jitter associated with the periodic data transmission, a traffic characteristic associated with the periodic data transmission, a periodicity associated with the periodic data transmission, a configuration of a cell used to transmit the periodic data transmission, a quantity of user equipment served by the cell used to transmit the periodic data transmission, a processing constraint of a base station, information regarding an arrival time at the user equipment for an uplink data transmission, or a combination thereof.

9. The user equipment of claim 1, wherein the duration information comprises an indication to switch to the first search space set group based on a discontinuous reception duration.

10. The user equipment of claim 9, wherein the indication to switch to the first search space set group specifies that the user equipment is to switch to the first search space set group based on a beginning of a discontinuous reception ON duration that occurs after the switch to the second search space set group.

11. The user equipment of claim 9, wherein the processor is further configured to receive the indication to switch to the first search space set group via downlink control information (DCI).

12. The user equipment of claim 11, wherein the indication to switch to the first search space set group comprises a codepoint value.

13. The user equipment of claim 1, wherein the processor is further configured to receive the duration information via downlink control information (DCI).

14. The user equipment of claim 1, wherein the processor is further configured to receive the duration information via a medium access control-control element (MAC-CE).

15. A method for wireless communication at a user equipment, the method comprising:
receiving a search space set grouping configuration including a first search space set group and a second search space set group;
receiving a first data burst of a periodic data transmission;
receiving duration information for a search space set group switch associated with the first data burst;
receiving an indication to switch to the second search space set group;
switching to the second search space set group based on the indication; and
receiving a second data burst of the periodic data transmission after switching to the first search space set group at a time that is based on the duration information.

16. A base station, comprising:
a transceiver;
a memory; and
a processor coupled to the memory and the transceiver, wherein the processor is configured to:
transmit, via the transceiver, a search space set grouping configuration including a first search space set group and a second search space set group;
transmit, via the transceiver, a first data burst of a periodic data transmission;
transmit, via the transceiver, duration information for a search space set group switch associated with the first data burst;
transmit, via the transceiver, an indication to switch to the second search space set group; and
transmit, via the transceiver, a second data burst of the periodic data transmission.

17. The base station of claim 16, wherein the duration information is indicative of a timer value for a timer for switching a user equipment to the first search space set group.

18. The base station of claim 16, wherein the processor is further configured to transmit the indication to switch to the second search space set group via downlink control information (DCI).

19. The base station of claim 16, wherein the duration information comprises an absolute timer value for a timer for the switching to the first search space set group.

20. The base station of claim 16, wherein:
the processor is further configured to transmit, via the transceiver, a list of absolute timer values for a timer for the switching to the first search space set group; and
the duration information comprises an indication of a particular absolute timer value from the list of absolute timer values.

21. The base station of claim 16, wherein the duration information comprises a relative timer value for a timer for the switching to the first search space set group.

22. The base station of claim 16, wherein:
the processor is further configured to transmit, via the transceiver, a list of relative timer values for a tinier for the switching to the first search space set group; and
the duration information comprises an indication of a particular relative timer value from the list of relative timer values.

23. The base station of claim 16, wherein the processor is further configured to determine the duration information based on at least one of: a quality of service associated with the periodic data transmission, a downlink data arrival time associated with the periodic data transmission, jitter associated with the periodic data transmission, a traffic characteristic associated with the periodic data transmission, a periodicity associated with the periodic data transmission, a configuration of a cell used to transmit the periodic data transmission, a quantity of user equipment served by the cell used to transmit the periodic data transmission, a processing constraint of the base station, information received from a user equipment regarding an arrival time of uplink data, or a combination thereof.

24. The base station of claim 16, wherein the processor is further configured to:
determine first duration information;
determine second duration information associated with the first data burst;
determine that the second duration information is different from the first duration information; and
transmit the duration information based on the determination that the second duration information is different from the first duration information.

25. The base station of claim 16, wherein the duration information comprises an indication to switch to the first search space set group based on a discontinuous reception duration.

26. The base station of claim 25, wherein the indication to switch to the first search space set group specifies that a user equipment is to switch to the first search space set group based on a beginning of a discontinuous reception ON duration that occurs after the switch to the second search space set group.

27. The base station of claim 25, wherein:
the processor is further configured to transmit the indication to switch to the first search space set group via downlink control information (DCI); and
the indication to switch to the first search space set group comprises a codepoint value.

28. The base station of claim 16, wherein the processor is further configured to transmit the duration information via downlink control information (DCI).

29. The base station of claim 16, wherein the processor is further configured to transmit the duration information via a medium access control-control element (MAC-CE).

30. A method for wireless communication at a base station, the method comprising:
transmitting a search space set grouping configuration including a first search space set group and a second search space set group;
transmitting a first data burst of a periodic data transmission;
transmitting duration information for a search space set group switch associated with the first data burst;
transmitting an indication to switch to the second search space set group; and
transmitting a second data burst of the periodic data transmission.
